(19) United States
(12) Patent Application Publication
(10) Pub. No.: US 2014/0115432 A1
(43) Pub. Date: Apr. 24, 2014

(54) TECHNIQUES FOR TYPOGRAPHIC ELECTRONIC PAGINATION

(71) Applicant: EPAGINATION LIMITED (UK), Nottinghamshire (GB)

(72) Inventor: Michael George TURNER, Durham (GB)

(73) Assignee: ePAGINATION LIMITED (UK), Nottinghamshire (GB)

(21) Appl. No.: 13/659,841

(22) Filed: Oct. 24, 2012

(51) Int. Cl. G06F 17/00

(52) U.S. Cl. 715/205; 715/251

(57) ABSTRACT

Techniques for typographic electronic pagination are disclosed. In one embodiment, the techniques may be realized as an apparatus for typographic electronic pagination. In one implementation of the apparatus, the apparatus comprises at least one non-transitory processor readable storage medium with instructions stored on the at least one medium. The instructions are configured to be readable by at least one non-transitory processor and cause the at least one processor to operate. The processor operates so as to receive a plurality of articles, generate an index page based on relative visual weightings of the plurality of articles and a size of a canvas adapted to contain the index page, and generate a page layout for the plurality of articles based on page layout weightings and the size of canvas.

### FIELD OF THE DISCLOSURE

The present disclosure relates generally to typographic layout and, more particularly, to techniques for typographic layout and pagination of electronic or digital media.

### COPYRIGHTED MATERIALS

Some of the figures in this application include screen captures with information from the British Broadcasting Corporation (BBC) for the limited purpose of illustrating the behavior of a non-limiting, working prototype of an embodiment of the present disclosure. The inventor claims no rights to the text or image content from the BBC found herein.

### BACKGROUND OF THE DISCLOSURE

Typography is the art of arranging type (i.e., text). For purposes of this disclosure, typographic layout also includes procedures for arranging text and graphics according to a desired appearance. Newspapers, books, magazines, webpages, and other types of media may have styles and typographical conventions associated with them to produce a particular look-and-feel.

For example, newspapers often follow a particular pattern. The front page of a newspaper may contain the logo of the newspaper, the date, and other pertinent information about the newspaper itself. The most popular or newsworthy story typically appears at the top of the front page with the largest headline and the largest image (e.g., a photo or illustration), and other, “less important” stories may fill in the surrounding space with relatively smaller headlines. Adjacent to each headline, the beginning of the corresponding article may fill in the remaining space, along with a reference to the newspaper page containing the remainder of the article.

A reader often scans the articles on the front page of the newspaper to determine whether to read any of the articles in more detail or to even purchase the newspaper in the first place. Thus, in many instances, a newspaper's front page includes a relatively large number of headlines and corresponding portions of the articles so that the reader can quickly scan many articles contained in the newspaper. However, including a large number of articles on the front page leaves less space for each of the individual articles. In other words, because the space on the front page is limited, for each article, the headline of the article and a only relatively small portion of the article often can be included on the page. These portions of the articles may be considered “article previews,” which the reader can quickly read to determine if he or she would like to read one or more of the articles in their entireties. Although an article preview includes just a small portion of the article, it may sometimes include the majority, or even all, of the article depending on the article's length.

The articles and article previews themselves typically conform to well-defined typographic standards, such as font type, font size, leading (or line spacing), kerning (or character spacing), and column width. In addition, the amount of text included within an article preview may be selected to ensure that the preview ends with a full stop (or period), marking the end of a complete sentence.

Designing and creating a typographically correct and aesthetically pleasing newspaper requires substantial manual effort in terms of repeatedly and successive sizing, positioning, and adjusting the newspaper content to achieve a tight fit for the content on the pages. Often, this manual process is time consuming because it requires a lot of “trial and error” to repeatedly resize and fit the headlines, text, and illustrations onto the pages of the newspaper until they form an aesthetically pleasing layout. For example, to achieve an aesthetic appearance, the newspaper pages should have little, if any, unused blank space, or “whitespace.” Since the remaining whitespace on a page often varies significantly in size and dimension due to the sizes and lengths of the articles and/or previews already laid out on the page, a lot of effort is required to resize and reformat additional articles to be included on the page such that there is relatively little or no whitespace and such that the articles remain visually pleasing and logically oriented.

In some electronic layout systems, it is impractical for a designer to craft well-designed pages of content for a multitude of formats, such as computers, tablets, smartphones, television screens, and e-readers without substantial manual effort. For example, a typical printed newspaper page is over 22 inches long and 15 inches wide, whereas a typical tablet might have a 10-inch screen. The labor-intensive process of resizing and reformatting articles for the newspaper's print publication cannot be shoehorned easily into the smaller dimensions of the tablet. Instead, a designer would need to start the resizing process from the beginning with the smaller screen dimensions in mind. Moreover, it would be difficult for a designer to craft well-designed pages for a screen or paper of arbitrary dimensions because each new set of dimensions would require the designer to perform the resizing process. Each additional screen or paper size requires additional time, effort, and human resources.

To eliminate the manual effort, some automated layout systems take shortcuts that often involve the use of templates. A template might specify particular regions for images or text and particular fonts and font sizes, but the templates have limited flexibility. Consequently, even complex conventional templates do not adjust the properties of the content to conform to typographically correct and aesthetically pleasing standards.

For example, the British Broadcasting Company (BBC) publishes news articles to its website at http://www.bbc.co.uk/news/. FIG. 28 shows a representative news article published with the BBC template for news articles on computer web browsers. Computer screens vary widely in size, so the BBC template restricts the width of its articles to accommodate a majority of screens. Consequently, on some computer screens, the article is sandwiched between two wide regions of whitespace such as whitespace region 2800. Headline 2810 spans across two columns, but the second column 2801 consists of mostly whitespace. Additionally, because the template sets a uniform width for all headlines, headline 2810 spans two lines, leaving just a single word on the second line and introduces yet another region of whitespace above the image. The main body of text appears in a single column at column 2820. The article is chopped up into one-sentence paragraphs, which also leads to excessive whitespace. Moreover, headlines, such as headline 2810, and images have a uniform size regardless of the relative importance of an article. The overall effect of the template is a cookie-cutter format for all news that fails to conform to numerous typographic standards that readers of printed newspapers expect and is not very appealing visually.

### SUMMARY OF THE DISCLOSURE

Techniques for typographic electronic pagination are disclosed. In one embodiment, the techniques may be realized as an apparatus for typographic electronic pagination. In one implementation, the apparatus comprises at least one non-transitory processor readable storage medium with instructions stored on the at least one medium. The instructions are configured to be readable by at least one non-transitory processor and cause the at least one processor to operate. The processor operates so as to receive a plurality of articles and generate an index page based on relative visual weightings of the plurality of articles and a size of a canvas adapted to contain the index page.

In another exemplary embodiment of an apparatus, the instructions are configured to cause the at least one processor to operate so as to receive a plurality of articles and generate a page layout for the plurality of articles based on page layout weightings and a size of a canvas adapted to contain the page layout.

In another exemplary embodiment of an apparatus, the instructions are configured to cause the at least one processor to operate so as to receive a plurality of articles, generate an index page based on relative visual weightings of the plurality of articles and a size of a canvas adapted to contain the index page, and generate a page layout for the plurality of articles based on page layout weightings and the size of canvas.

### BRIEF DESCRIPTION OF THE DRAWINGS

Reference is now made to the accompanying drawings, in which like elements are referenced with like numerals. These drawings should not be construed as limiting the present disclosure, and are intended to be illustrative only.

FIG. 1 shows a function of a server that performs typographic electronic pagination in accordance with an embodiment of the present disclosure.

FIG. 2 depicts applications of a computer system for typographic electronic pagination in accordance with an embodiment of the present disclosure.

FIG. 3 depicts a block diagram of a computer system for typographic electronic pagination in accordance with an embodiment of the present disclosure.

FIG. 4 shows a method for typographic electronic pagination in accordance with an embodiment of the present disclosure.

FIG. 5 shows a method for screen-based index page creation in accordance with an embodiment of the present disclosure.

FIG. 6 depicts a method for page layout creation in accordance with an embodiment of the present disclosure.

FIG. 7 shows a method for body column creation in accordance with an embodiment of the present disclosure.

FIG. 8 shows an example of unformatted data input in accordance with an embodiment of the present disclosure.

FIG. 9 shows an example of a screen-based index page in accordance with an embodiment of the present disclosure.

FIG. 10 depicts an example of an article page layout in accordance with an embodiment of the present disclosure.

FIG. 11 depicts another example of an article page layout in accordance with an embodiment of the present disclosure.

FIG. 12 depicts an example of an article page layout with matched articles in accordance with an embodiment of the present disclosure.

FIG. 13 shows an example of an article page layout with image and advertisement elements in accordance with an embodiment of the present disclosure.

FIG. 14 shows another example of an article page layout with matched articles and an advertisement element in another configuration in accordance with an embodiment of the present disclosure.

FIG. 15 depicts another example of an article page layout with image and advertisement elements in a different configuration in accordance with an embodiment of the present disclosure.

FIG. 16 shows another example of an article page layout with two complete matched articles in accordance with an embodiment of the present disclosure.

FIG. 17 shows an example of flipping from one article page layout to the next in accordance with an embodiment of the present disclosure.

FIG. 18 shows typographic parameters and settings for article page layouts in accordance with an embodiment of the present disclosure.

FIG. 19 shows additional typographic parameters and settings for article page layouts in accordance with an embodiment of the present disclosure.

FIG. 20 depicts typographic parameters and settings for screen-based index page creation in accordance with an embodiment of the present disclosure.

FIG. 21 depicts additional typographic parameters and settings for screen-based index page creation in accordance with an embodiment of the present disclosure.

FIG. 22 shows an example of an interface for adding content for typographic electronic pagination in accordance with an embodiment of the present disclosure.

FIG. 23 shows an example of an interface and preview for real time layouts in accordance with an embodiment of the present disclosure.

FIG. 24 shows another example of an interface and preview for real time layouts in accordance with an embodiment of the present disclosure.

FIG. 25 shows an example of typographic electronic pagination for screens with multiple orientations.

FIG. 26 shows yet another example of an interface and preview for real time layouts in accordance with an embodiment of the present disclosure.

FIG. 27 depicts an additional example of an interface and preview for real time layouts in accordance with an embodiment of the present disclosure.

FIG. 28 shows an example of a template-based news website layout.

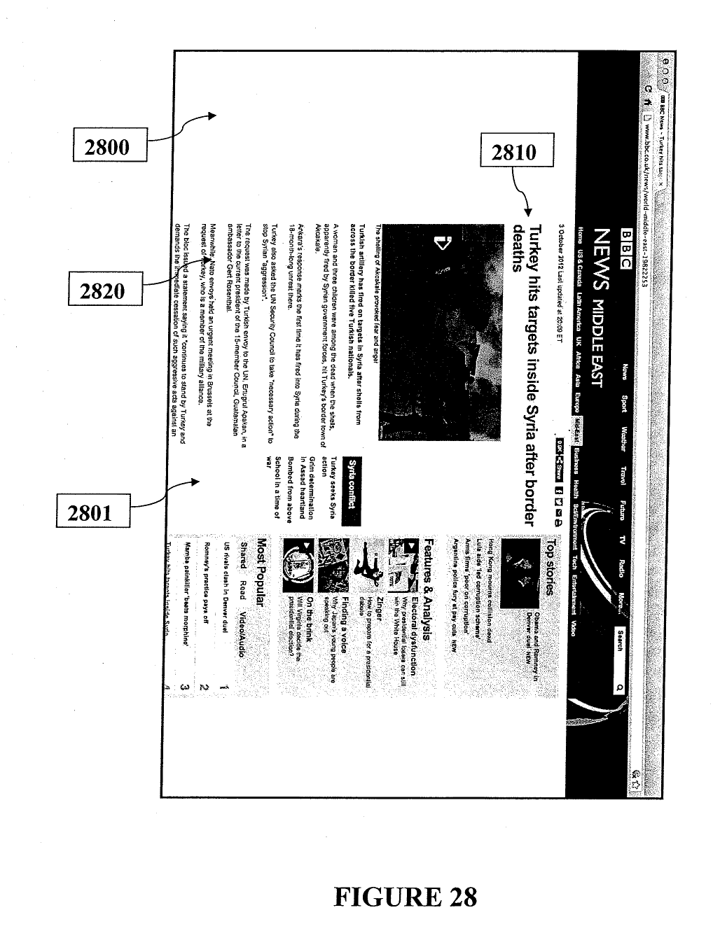

FIG. 29 shows an example of matching two articles according to a range of possible sizes.

### DETAILED DESCRIPTION OF EMBODIMENTS

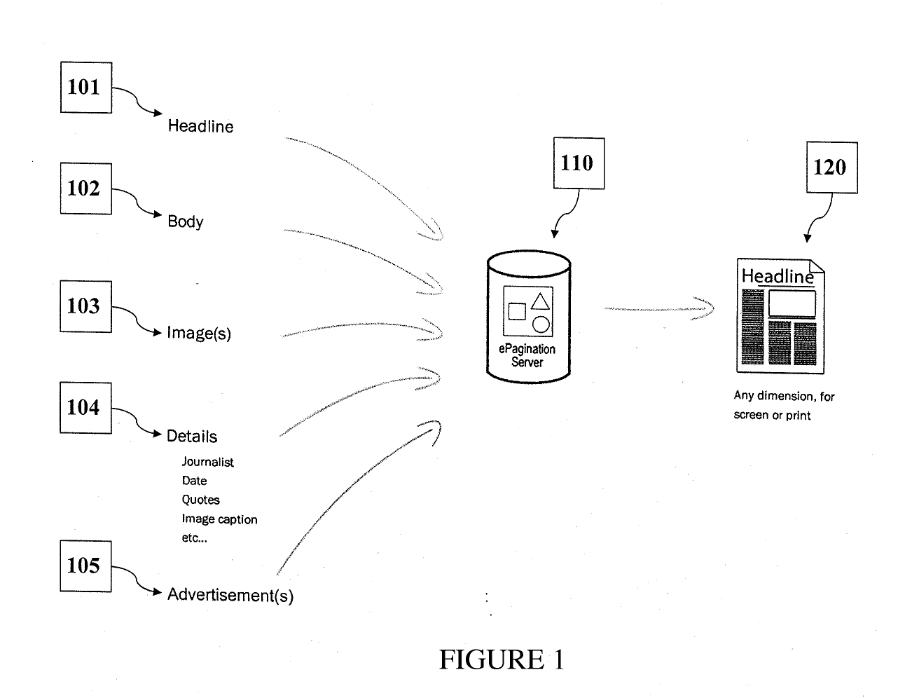

FIG. 1 shows a server that performs typographic layout or pagination of electronic media in accordance with an embodiment of the present disclosure. As shown, an ePagination Server 110 performs layout and pagination of electronic media for a screen or page 120 having arbitrary dimensions. Although the screen or page 120 has arbitrary dimensions, other embodiments can perform pagination for screens and pages with fixed dimensions.

The ePagination Server 110 may include a non-transitory processor readable medium with instructions configured to perform typographic electronic pagination. In other embodiments, the ePagination Server 110 represents one or more processors configured to perform typographic electronic pagination or may represent one or more servers in a local area network or wide area network such as the Internet or other cloud-computing environment. The ePagination Server 110 may be operated by a content provider or as a typographic electronic pagination software-as-a-service.

The ePagination Server 110 may receive content, such as electronic media, as input. The content, such as an article, may include various elements such as a headline 101, body text 102, one or more images 103, one or more advertisements 105, and other article details 104, including, for example, the name of the journalist or author, the date of publication, quotations, captions for the one or more images 103, and other details. The Server 110 may perform typographic electronic pagination on the content and output typographically correct and aesthetically pleasing content layouts for the screens or printed pages 120.

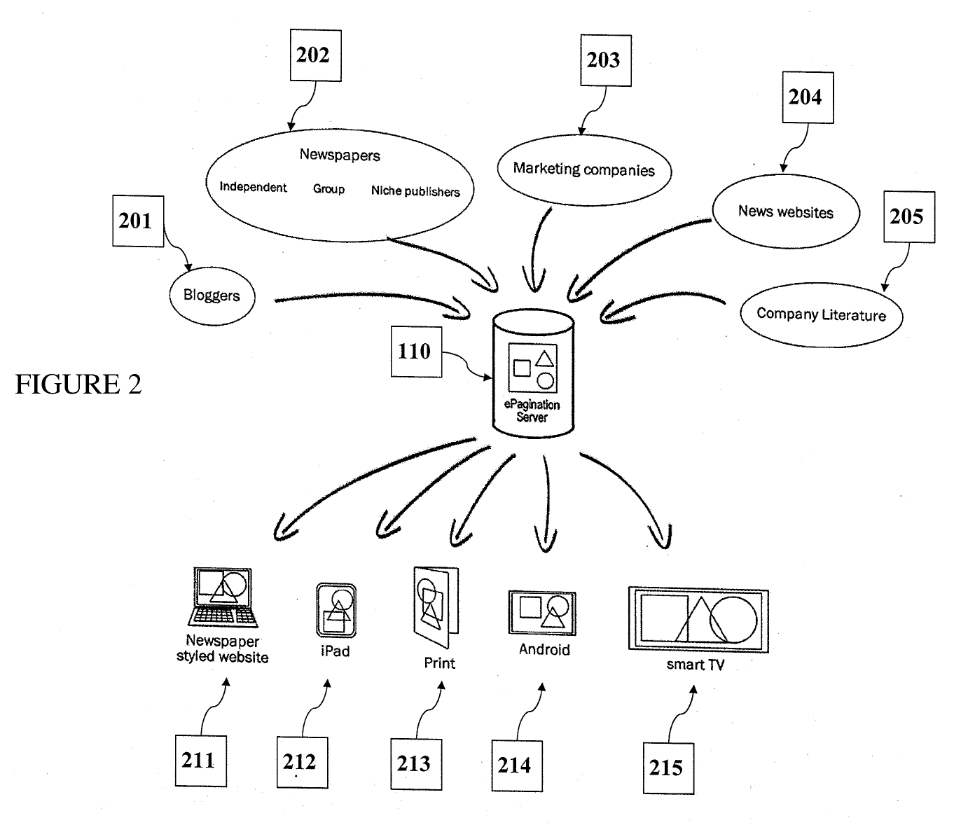

FIG. 2 depicts an embodiment in which the ePagination Server 110 is integrated into a computer system for typographic electronic pagination in accordance with an embodiment of the present disclosure. The Server 110 may receive content from one or more types of sources, such as blogs 201, newspapers 202, marketing companies 203, news websites 204, and company literature 205. These content sources 201-205 may provide raw, unformatted content and may provide content according to syndication standards such as Really Simple Syndication (RSS), Atom, or other standards.

For any of the content sources 201-205, the ePagination Server 110 performs typographic electronic pagination for one or more types of screens or printed pages having arbitrary dimensions 120. For example, the screens may include websites styled as newspapers 211, tablets 212 (such as an Apple iPad), smartphones 214 (such as an Android OS device or an iPhone), or televisions 215 with network connectivty (such as a Smart TV). Some screens (e.g., tablet screens) may support touchscreens and multiple orientations (e.g., portrait orientation and landscape orientation). Additionally, printed pages 213 may include newspapers, brochures, pamphlets, booklets, or flyers with multiple orientations and sizes (e.g., letter, A4, etc.). These printed pages may be printed from a printer (not shown) connected to the server 110 or connected to a computer (not shown) coupled to the server 110. Such connections may be local or over a network.

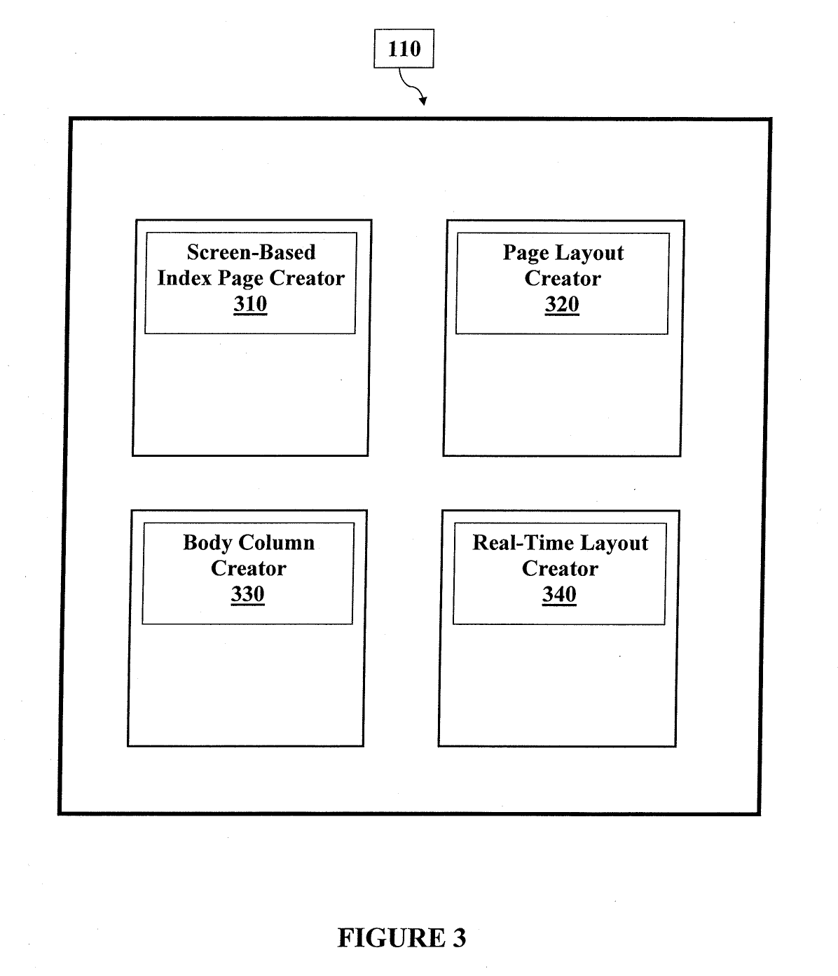

FIG. 3 show a more detailed embodiment of the ePagination Server 110. As shown, the server 110 comprises a screen-based index page creator 310, a page layout creator 320, and a body column creator 330. The ePagination Server 300 may also include a real-time layout creator 340. These creators 310-340 can be implemented in software, hardware, or a combination of software and hardware. In addition, although the creators 310-340 are shown as four distinct units or modules, some or all of them can be combined into a single unit or module. For example, the creators 310-340 can form a single software program executed by a single processor or distributed among multiple processors. Alternatively, the creators 310-340 can comprise multiple software programs executed by one or more processors.

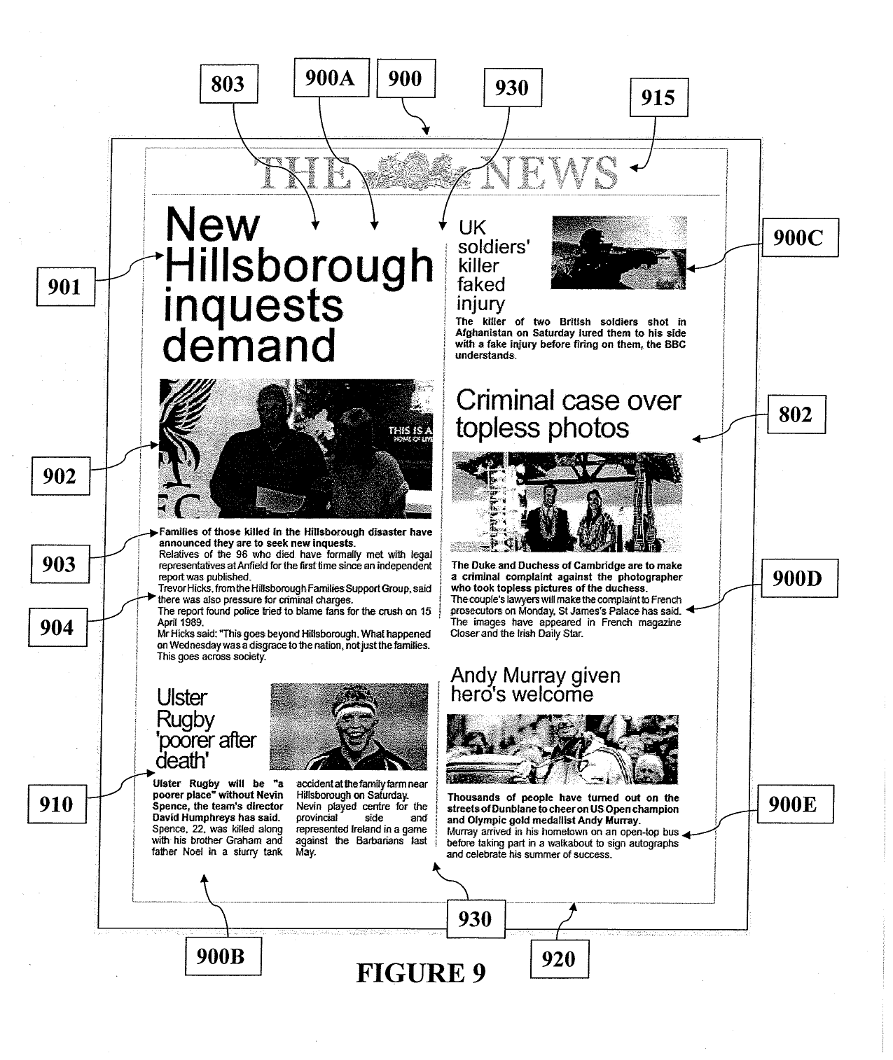

In any event, in one implementation, the screen-based index page creator 310 creates screen-based index pages. An index page may contain one or more headlines and portions or summaries of the corresponding articles supplied from article content sources 201-205 (FIG. 2). The index page allows a reader to quickly “preview” the headlines and article portions/summaries to determine which article the reader would like to purchase or read in more detail. Thus, the headlines and article portions/summaries can be considered to be article previews, as discussed above. FIG. 9 shows an example of an index page 900 that contains several headlines and article portions. The index page 900 conforms to typographic parameters, and the sizes and positions of the article previews 900A-900E on the index page 900 may correspond to articles' relative visual weighting. For example, previews of more popular or newsworthy articles may have a larger headline and font size and may be located at the top left of the index page 900. FIG. 9 and other aspects of index pages are described in more detail below.

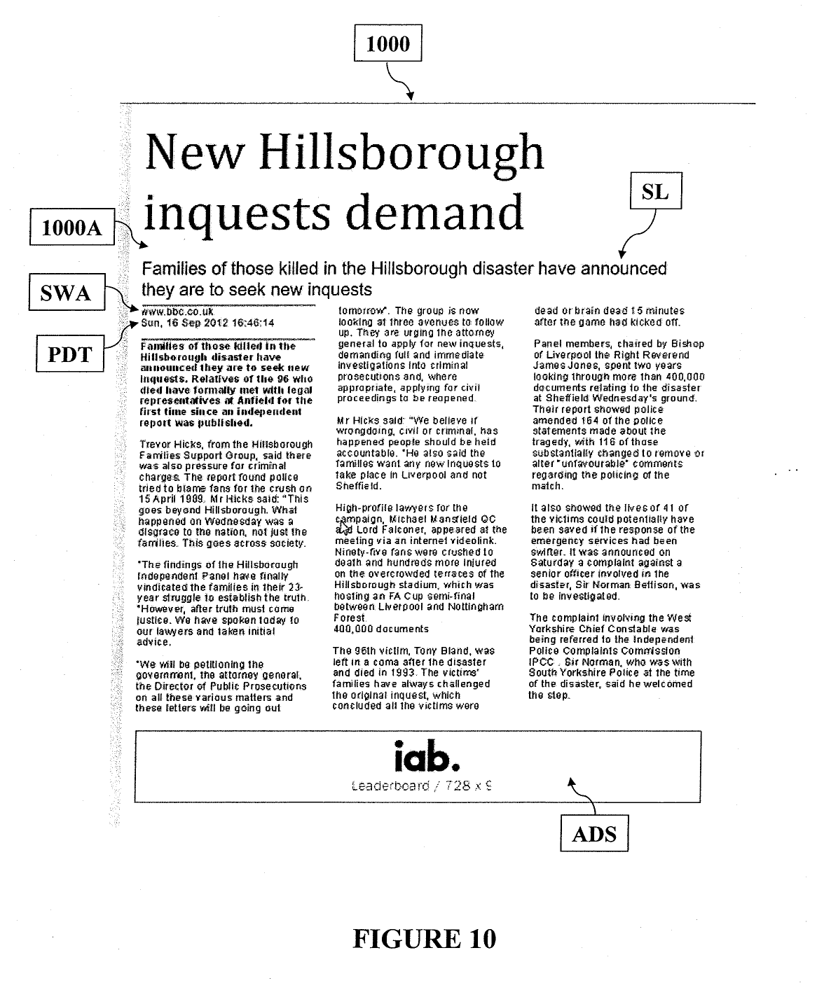

In one embodiment, the page layout creator 320 creates a layout for one or more pages containing articles received from the content sources 201-205 (FIG. 2). The page layout creator 320 may fit one or more articles onto one or more pages. Longer articles may begin on one page and overflow onto one or more subsequent pages, while multiple shorter articles may fit on a single page. The number of articles on a page and the manner in which they are laid out on the page depend on specified typographical parameters for the articles and pages and depend on the size of the articles. Although the page layout creator 320 is described in terms of laying out “pages,” upon reviewing the present application, one skilled in the art will appreciate that “pages” can refer to printed pages or electronic pages displayed on a screen of an electronic device. For instance, a reader can read multiple, sequential electronic pages by instructing an electronic device to sequentially display each page on the device. An example of articles having a layout created by the page layout creator 320 is shown in FIGS. 10-16, which are described in more detail below.

In one implementation, the body column creator 330 determines how many columns are used for organizing the text of an article and how the column(s) of text are fit around the “points of interest” of the other objects of the article, such as the vertices or corners of headlines, images, and other article details. In addition, the creator 330 may be used to determine how the column(s) of text fit around other objects, such as an area on a page designated for advertisements. In some embodiments, the screen-based index page creator 310 may use the body column creator 330 to determine the number and format of the columns of the article previews and the relative orientation of the column(s), headline, image(s), etc. of each article preview in the index page 900 (FIG. 9). Similarly, the page layout creator 320 may use the body column creator 330 to determine the number of column(s) of each article and the relative orientation of the column(s), headline, image(s), etc. of each article on various pages, as shown in FIGS. 10-16.

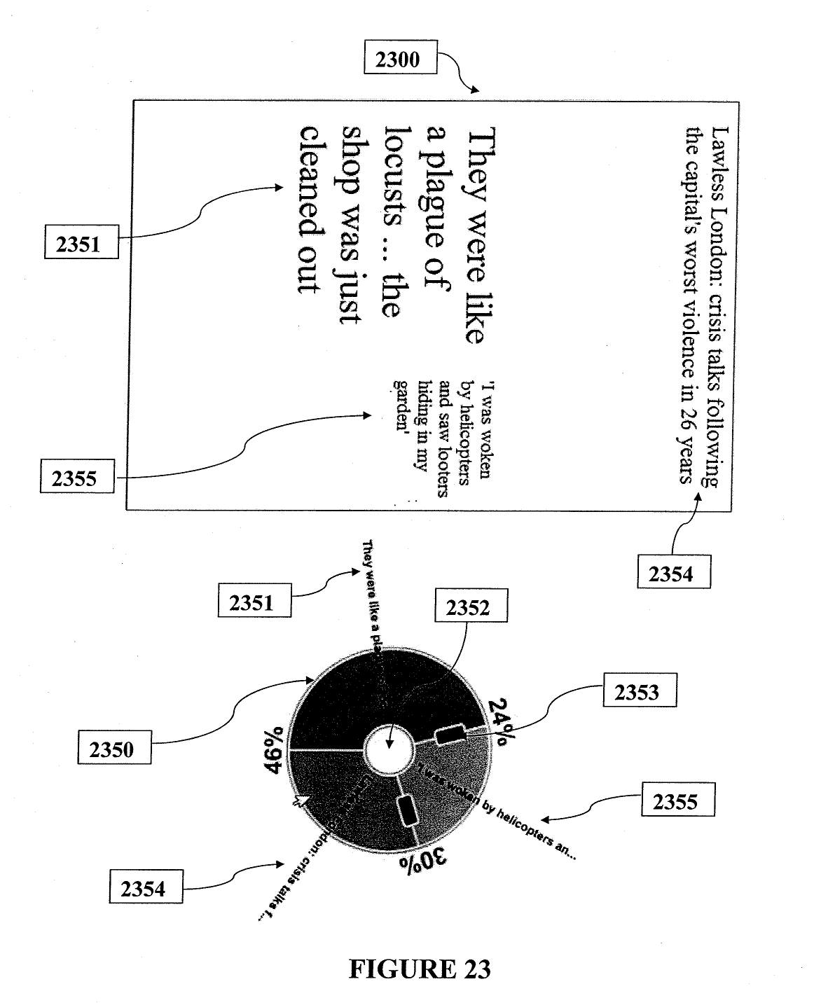

In some embodiments, the content retrieval and typographic electronic pagination may be fully automated, whereby the system automatically downloads the latest articles from one or more news feeds and creates layouts that conform to preconfigured typographic settings. In other embodiments, a content provider may select a preferred layout from among multiple quasi-randomized variations of layouts that all conform to the relative weightings of articles and specified typographical parameters. Although an element of randomness enables the system to create multiple unique variations of layouts, each variation adheres to preconfigured typographic parameters. In still other embodiments, a content provider or designer may manipulate typographic parameters and layouts using the real-time layout creator 340. Examples of interfaces for, and the operation of, the real-time layout creator 340 are described in detail below with respect to FIGS. 23-27.

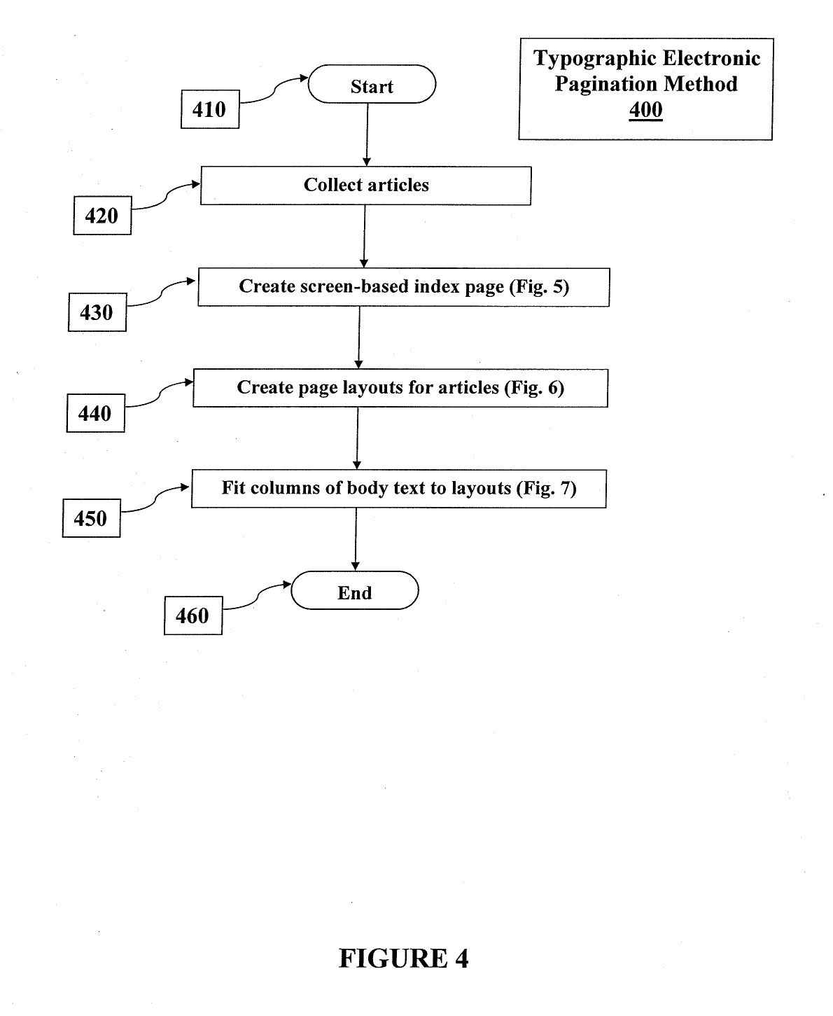

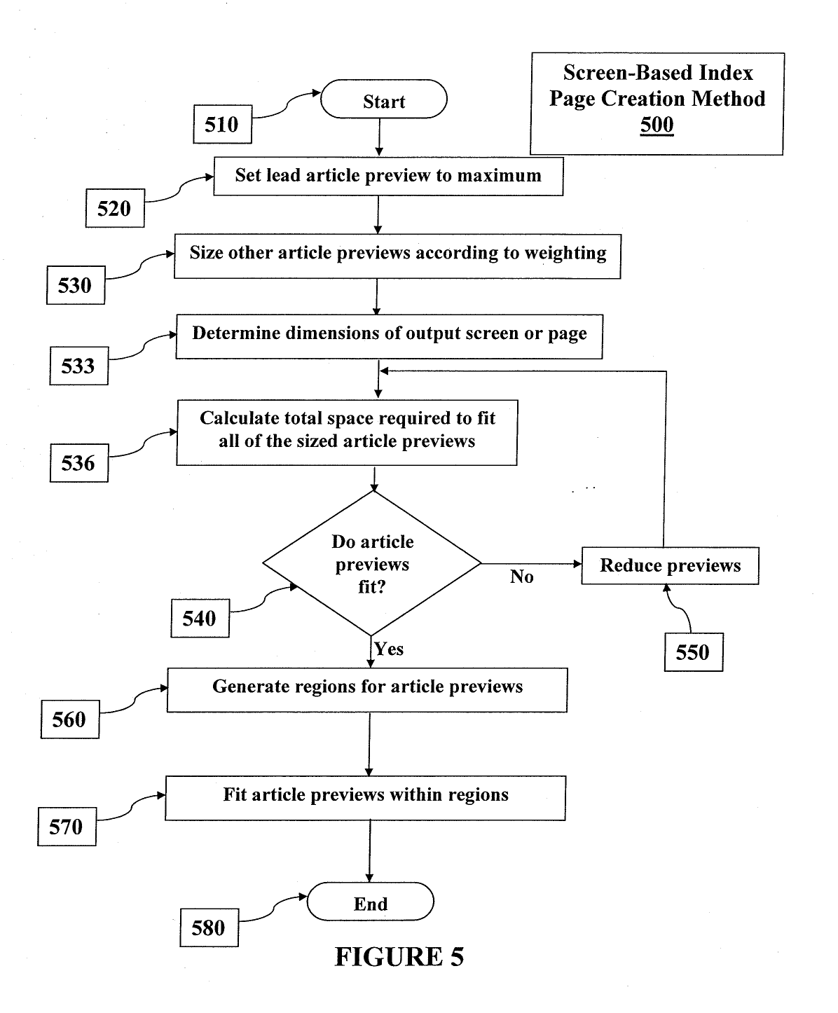

FIG. 4 shows an exemplary method 400 that the ePagination Server 110 performs. Of course, not all of the operations depicted in FIG. 4 (and FIGS. 5-7, which also illustrate flow diagrams) need to be performed in the order shown, and some operations may be performed simultaneously with other operations.

After the method 400 begins (block 410), the ePagination Server 110 collects articles from one or more sources 201-205 (FIG. 2) (block 420). As noted above, these articles may be collected from a wide variety of content sources and content types, including RSS, Atom, or other syndication standard feeds. Articles may also be copied and pasted, typed, or otherwise input directly by a user.

Then, the screen-based index page creator 310 creates a screen-based index page (such as index page 900 (FIG. 9)) containing article previews for the articles (block 430), the page layout creator 320 creates the page layouts for the articles (such as the articles shown in FIGS. 10-16) (block 440), and the body column text creator 330 formats the text of the articles of the printed or screen pages as well as the article previews of the index page into one or more columns. The column or columns are then fitted based on the layout of the printed or screen pages and the index page (block 450). More detailed examples of the operations of the screen-based index page creator 310 (block 430), the page layout creator 320 (block 440), and the body column text creator 330 (block 450) are respectively described in conjunction with FIGS. 5-7 below.

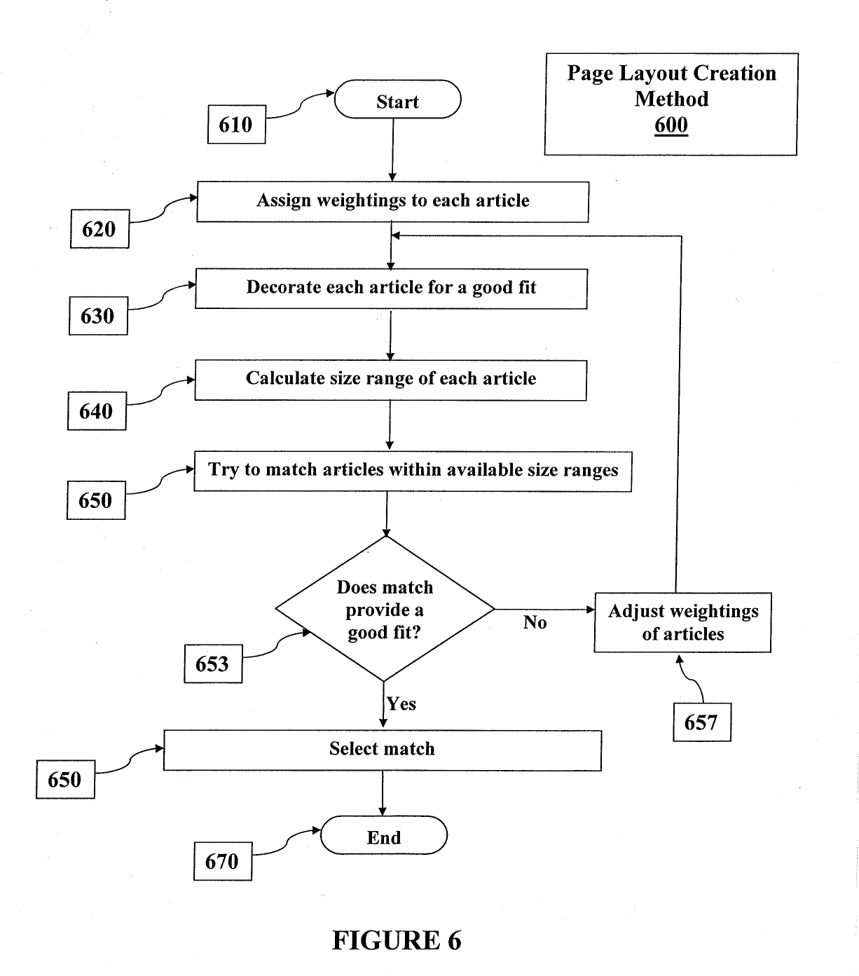

At blocks 430-450, the ePagination Server 110 determines whether the article content satisfies threshold finesses that conforms to the specified typographical standards (see, for example, FIG. 5 (block 540), FIG. 6 (block 653), and Figure (block 750). A threshold fitness is a point at which the actual typographical settings for a particular article produces a layout that is sufficiently aesthetically correct. Given unlimited time and computational resources, it might be possible to find alternative typographical settings that produce a conforming layout that is even more balanced and aesthetically correct. The threshold fitness is the point at which the system will determine that a particular layout is good enough, and it can stop adjusting typographic settings looking for better layouts. As set forth in more detail in FIGS. 5-7, if the article content does not satisfy a threshold fitness, the ePagination Server 110 adjusts the article content elements as described in more detail below.

In some embodiments, the server 110 may repeat the process one or more times to generate several variations of layouts that all satisfy the threshold fitness. These quasi-randomized layouts may be presented to a publisher or other user, and the publisher or user may review the several options and choose the layout that he or she prefers. After finalizing the layouts, the operation ends (block 460).

FIG. 5 shows a more detailed example of a method 500 that the screen-based index page creator 310 performs in block 430 (FIG. 4) to create a screen-based index page. Moreover, in addition to being performed in conjunction with the typographic electronic pagination method 400 described above, the method 500 may be performed as a standalone process.

When the method 500 begins (block 510), the preview for a “lead article” of the various articles collected in block 420 (FIG. 4) is set to its maximum size (block 520). The lead article may be the article considered to be the most popular or newsworthy article of all of the received articles, and its article preview may be assigned the highest weighting relative to the remaining articles. In some embodiments, content provider for one of the sources 201-205 may designate which article is the lead article. In other embodiments, the screen-based index page creator 310 may automatically select the lead article. For example, the first article in an RSS feed, the most recently published article, or the article known to be most popular may be designed as the lead article, and its preview may be assigned the highest relative visual weighting.

The maximum size of the lead article preview may be determined based on specified typographic parameters. For example, the headline of the lead article preview may have a maximum font size, and its image may have a maximum width and/or height. Examples of these and other typographic parameters are described in more detail below.

The creator 310 may also size the previews for the remaining articles according to their relative visual weightings. For instance, the total relative visual weightings of all of the article previews should be 100%. As an example, if the lead article preview has a maximum visual weighting of 60%, two remaining article previews may have maximum visual weightings of 30% and 10%, respectively. The relative visual weightings of the article previews are created by appropriately sizing the elements of the preview, such as the font size of the headlines, the font size of the text of the portions of the articles shown on the index page, and/or the size of the images for the articles.

For instance, in one implementation, assume that the lead article preview, second article preview, and third article preview on the index page have relative visual weightings of 60%, 30%, and 10%, respectively. The screen-based index page creator 310 may create these relative weightings by setting the font size of the headline of the second article preview to be half of the font size of the headline of the lead article preview because the 30% weighting is half of the 60% weighting. Similarly, the font size of the headline of the third article preview may be one-sixth of the font size of the headline of the lead article preview because the 10% weighting is one-sixth of the 60% weighting.

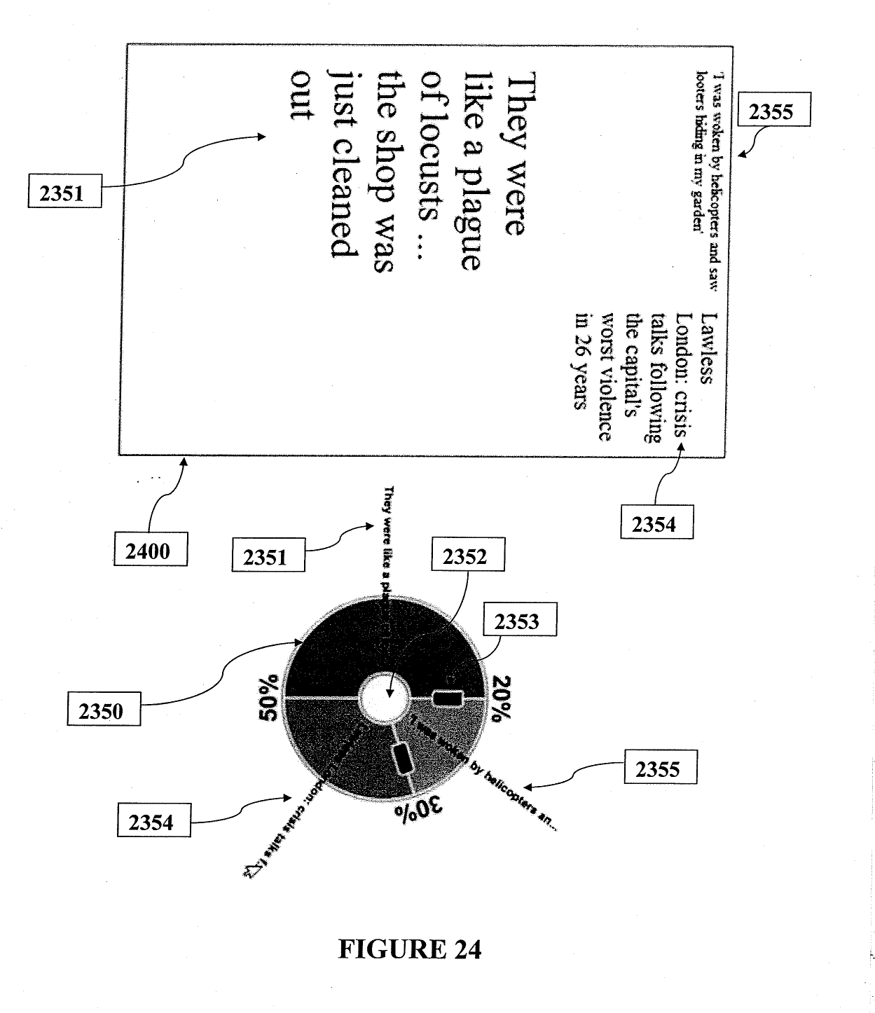

Another example is found in FIG. 24. Preview pane 2400 displays three headlines 2351, 2354, and 2355 in a partially rendered index page. The font size of each headline is correlated with the relative visual weighting assigned to each headline. In FIG. 24, the headlines 2351, 2354, and 2355 have weightings of 50%, 30%, and 20% respectively, as shown in the “weightings widget” 2350 (described in more detail below). Consequently, the lead article 2351 with a weighting of 50% is rendered in the preview pane 2400 with the largest font size, the article 2354 with a weighting of 30% is rendered with a font size that is approximately ⅗ the size of the lead article's font size, and the article 2355 with a weighting of only 20% is rendered with the smallest font size that is approximately ⅖ the size of the lead article's font size.

Although the example above relates to creating an index page with three article previews, the number of previews can be more or less than three. In this case, the relative visual weightings may be allocated so that the sum of the weightings equals 100%. For instance, if the index page is designed to contain five article previews, weightings of the lead article preview and the second through fifth article previews may be 40%, 30%, 10%, 10%, and 10%, respectively. The creator 310 can set the number of article previews included on an index page in a number of ways. For example, a user of the creator 310 can input data indicating the number of previews, the content provider of one or more of the sources 201-205 can include information indicating the number of previews to display on the index page, or the creator 310 can determine the number of previews to include on the index page based on the number of articles received from one or more of the sources 201-205.

If the size of the headline or other element of an article preview is smaller than a certain size, it may be difficult to read and/or not visually pleasing. Thus, in some embodiments, the screen-based index page creator 310 prevents the minimum size of a headline (or other object) of an article preview from being smaller than a minimum size. For example, if the lead article preview is set at a maximum size, and the headline of a lower weighted article preview is smaller than the minimum size, then in block 530, the creator 310 may proportionally adjust the relative weightings of the lead article preview and the remaining article previews on the index page so that the lead article preview still has the highest visual impact and such that the headlines of the lower weighted article previews are larger than the minimum size.

For example, if there are two articles with relative weightings of 80% and 20% respectively, the font size of the lead article with a weighting of 80% should be four times as large as the font size of the other article with a weighting of 20%. If the minimum headline font size parameter is set to 20 points, the lead article's headline size must be at least 80 points. If the lead article does not fit within the dimensions of the canvas and must be reduced to 60 points in order to fit, the other article's headline font size would need to be reduced to only 15 points to maintain the relative visual weightings of 80% and 20%. In this case, the second article's headline font size would drop below the specified minimum font size, resulting in an index page that does not conform to the specified typographic settings. Thus, to preserve conformance, the second article's headline font size would not be reduced below 20 points. Consequently, the relative visual weighting of the lead article with a headline font size of 60 points would be 75%, and the relative visual weighting of the second article would be 25%. In other words, the relative visual weightings are adjusted from a 4:1 ratio to a 3:1 ratio in order to conform to a preconfigured typographic setting.

The creator 310 may set the minimum headline size according to typographic parameters. These parameters may be set based on data input by a user or other methods described above.

After the article previews are sized in block 530, the creator 310 may determine the dimensions of the output screen or page (e.g., website 211, tablet 212, printed page 213 (letter size or A4)) displaying or containing the index page (block 533). The screen-based index page creator 310 may also calculate the total space required to fit all of the sized article previews (block 536). Afterwards, the creator 310 compares the calculated total space with the total space available on the output screen or page to determine if the sized article previews will fit on the output screen or page (block 540).

If the sized article previews are too large to fit on the output screen or page, the creator 310 may slightly reduce the size of the elements of the lead article preview (block 550). In some embodiments, the creator 310 may use quasi-randomization or a fitting algorithm to reduce one or more of the elements. Because the reduction may be partially random, the algorithm functions more like a creative human designer than a deterministic machine or template. For example, one or more of the headline font size, kerning (i.e., character spacing), or image size of the lead article may be reduced. One or more elements of the remaining articles may also be reduced according to the relative visual weightings of the articles. Then, the creator 310 again calculates the total space required to fit all of the resized article previews (block 536) and again compares the recalculated total space with the total space available on the output screen or page to determine if the resized article previews will fit on the output screen or page (block 540).

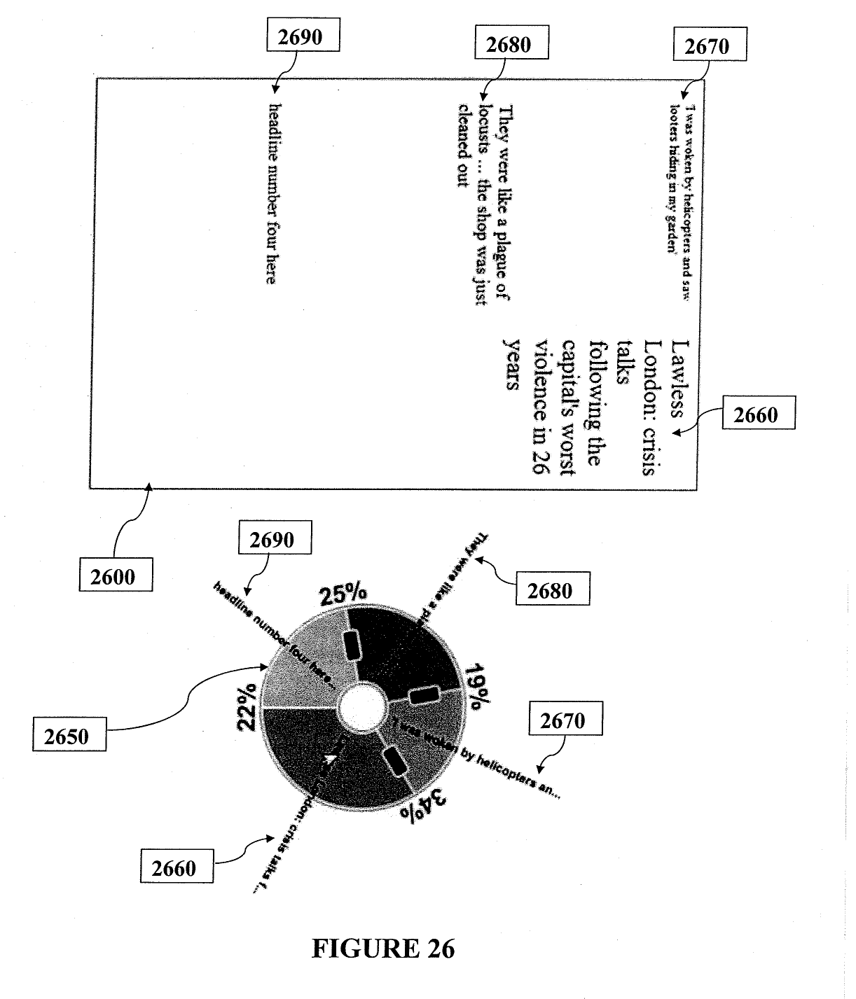

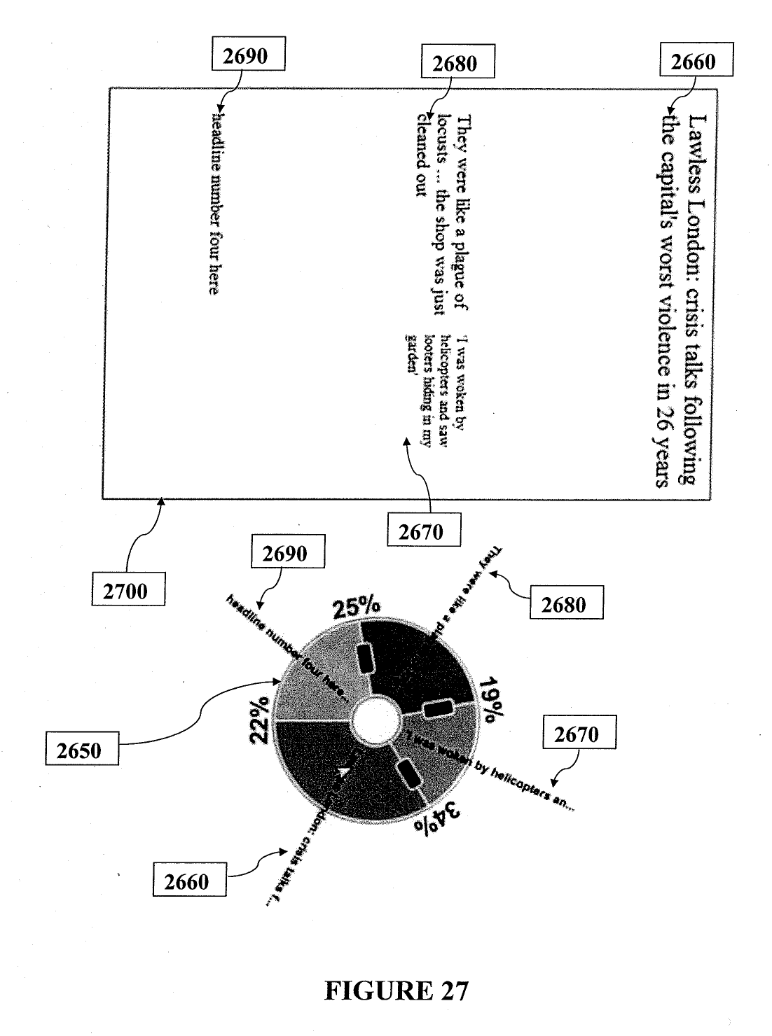

If the article previews are small enough to fit within the available space, the screen-based index page creator 310 generates regions on the index page for each article preview (block 560). For example, a quasi-randomized reordered treemap may be used. A treemap represents data (e.g., article previews) as a set of rectangles. Each rectangle's area is proportional to a specified property of data (e.g., an article preview's relative visual weighting). See Shneiderman, “Tree Visualization with Tree-maps: A 2-d Space-filling Approach,” ACM Transactions on Graphics (TOG), Vol. 11, Issue 1 (January 1992), at pp. 92-99, which is incorporated by reference in its entirety for all purposes. By using a treemap tiling algorithm that can reorder to the rectangles in a quasi-randomized fashion, an index page may generate a variety of potential layouts that are aesthetically pleasing and that conform to the specified typographic parameters. By using such an algorithm, the lead article preview (and other previews) may be located at different positions of the index page, although the lead article preview will have the highest visual weighting. For example, in FIGS. 26 and 27, four articles have weightings of 34%, 25%, 22%, and 19% respectively (see “weightings widget” 2650 in FIGS. 26 and 27). The preview pane 2600 in FIG. 26 shows the headlines laid out according to one treemap, and the preview pane 2700 in FIG. 27 shows the same headlines with the same weightings laid out according to a different treemap. Because the treemapping algorithm may incorporate elements of randomness, the particular layout may be different each time the algorithm is applied to a set of articles. The randomness of the treemapping algorithm may be subject to constraints imposed by the preconfigured typographic settings. For example, in some embodiments, the rectangle for the lead article preview is always mapped to the upper-left position of the index page, while the rectangles for the remaining article previews may be mapped to other quasi-random positions. The quasi-random treemapping algorithm in these embodiments restricts the position of the rectangle for the lead article but may still randomize the positions of the remaining articles.

For screen-based applications, it may be desirable to generate multiple index pages. For example, index pages may be created with a choice of small, medium, or large font sizes so that a reader may readily adjust the font size. Screen-based applications may also be adapted to render content in a way to facilitate night-reading such as with inverted or sepia-tone background colors. Moreover, the ePagination Server 110 may output index pages to more than one of the output devices 211-215 having different sized screens and pages. Thus, the creator 310 may create different sized index pages to be displayed on or generated by the different devices 211-215.

For screen-based applications, such as an Apple iPad tablet 212, a user may rotate the device to switch between portrait and landscape orientations. It may be desirable to generate both portrait and landscape index pages that are selectively displayed on the device depending on the device's orientation. In some embodiments, the portrait and landscape index pages may be correlated. For example, article previews should maintain the same relative position to one another in both orientations. In another example, the preview content for each article preview should contain the same number of sentences in both orientations. With these features, a user may be less likely to become disoriented upon rotating the device.

After the regions are generated in block 560, the creator 310 may fit the article previews in the respective regions. For example, in addition to the headline and optional image, one or more sentences of body content may be included as the preview of the article. In some embodiments, one sentence may be fitted first, and if additional space is available, additional sentences may be fitted one at a time until there is no longer sufficient space to fit additional sentences for the article in the region. To achieve a tight fit above a threshold fitness of the generated region, typographical features may be adjusted within acceptable ranges of the specified typographical settings. For example, the leading (i.e., line spacing) or kerning (i.e., character spacing) of the text of the article preview may be increased or decreased, the number of columns of text may be increased or decreased, and the width of the columns may be adjusted. This adjustment may continue until each article preview in each generated region of the treemap conforms to the predetermined typographic settings.

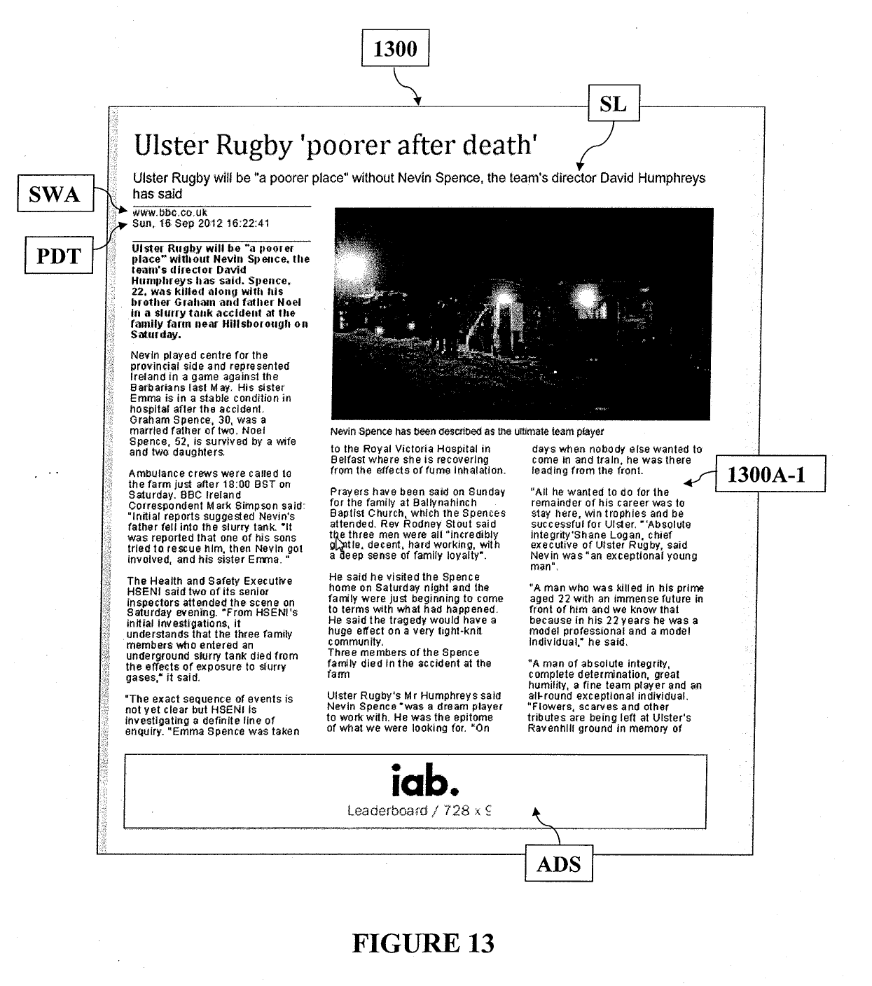

In screen-based applications, the article previews on the displayed index page may be hyperlinked so that tapping on, clicking on, or selecting an article preview will cause a page layout to appear that contains at least a first page of full article content related to the selected article preview. For example, if a user is viewing the index page 900 (FIG. 9) on a tablet 212, the user may tap the article preview 900B, in which case the user may be shown page layout 1300 (FIG. 13), which contains the full text of the article 1300A. In print applications, page numbers or other cross-references may be listed to indicate the page of printed text that contains at least a first page of full article content related to the cross-referenced article preview.

In some embodiments, additional design elements may be selected or applied automatically. For example, lined borders may be rendered around individual article previews. Referring again to index page 900 (FIG. 9), vertical borders 930 separate the article previews 900A-900B on the left side of the index page 900 from the article previews 900C-900E on the right side of the index page 900. Other configurations may show horizontal borders as well (not shown). In some embodiments, the creator 310 may be configured to render horizontal borders, vertical borders, or both horizontal and vertical borders. The styles of the borders may also be configured, such as the color, thickness, or shape of the border. The creator 310 may be configured to render only a part of a border so that, for example, the top 5% and the bottom 5% is shown as whitespace. For example, the vertical border 930 does not extend across the entire vertical length of the article preview area. Furthermore, in some embodiments, the length of the border may be determined by the longest article preview adjacent to the border. For example, the top portion of the vertical border 930 is sized according to the height of the taller preview 900A for the article 803 instead of the height of the shorter preview 900D for the article 802.

FIG. 6 shows a more detailed example of a method 600 that the page layout creator 320 performs in block 440 (FIG. 4) to create a full content page layout for an article. Unlike the index page (shown in FIG. 9), in which the headlines for the article previews are displayed on a single page, the articles in the full content page layouts may spread across multiple pages (as shown in FIGS. 10-16). Moreover, in addition to being performed in conjunction with the typographic electronic pagination method 400 described above, the method 600 may be performed as a standalone process.

As shown, after the method 600 begins (block 610), the creator 320 assigns a weighting to each article. Depending on the embodiment, weightings may be assigned manually or automatically based on various criteria. For example, the first two articles listed in a RSS feed may be designated “Main” articles, the next three articles may be designated “General” articles, and any remaining articles may be designated “Minor” articles. In this example, “Main” articles have the highest weighting, which may be conveyed using the largest font size for the headline. “General” articles have a medium weighting, which may be conveyed using a medium headline font size. “Minor” articles may have the lowest weighting, conveyed with the smallest headline font size.

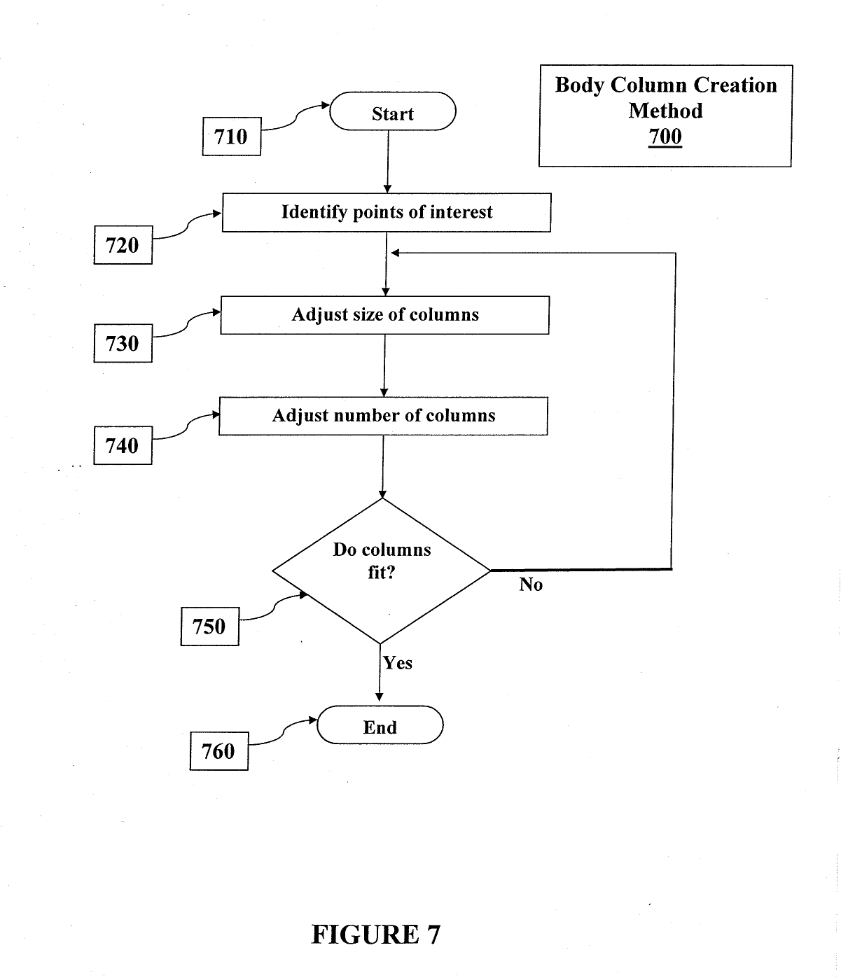

These page layout weightings may influence the relative size of the headline and image(s) between articles of one weighting and articles of another weighting, but a page layout weighting is independent of the length of an article. A very short article may be assigned a “Main” page layout weighting, and a lengthy article may be assigned a “Minor” page layout weighting. In addition to the weighting, the system may also determine the total space required for an article, which includes the body text the article. The space required for the body text may not necessarily depend on the weighting of the article, but it may depend on the values of various typographical features such as the number and size of columns of body text. The body column adjustment is described below with respect to method 700 of FIG. 7.

Afterwards, the page layout creator 320 may “decorate” each article for a good fit (block 630). Article decoration may include placing the headline, image, strapline, and other article elements in various positions and alignments within the page layout. In some embodiments, a fixed number of standard decorations may be applied in sequence until a decoration that provides a sufficient fit is found. Among the fixed number of standard decorations or layouts, some may be designed for Main articles, whereas others are designed for General or Minor articles. Depending on an article's weighting, several different decorations or layouts may be available that define the relative positions of the headline, optional images, and optional advertisements. The layouts may also account for other article features such as the strapline (e.g., subtitle or sub-headline) and other details such as the name of journalist or author and the article's publication date.

Different layouts may result in different degrees of “fitness,” whereby the fitness is a measure of the typographic correctness and aesthetic quality of a particular layout applied to a particular article. For example, a layout with a good fitness provides an alignment of a headline and an image that minimizes extraneous whitespace around the elements in the article. If no layout provides a sufficiently tight fit, elements of the article (e.g., headline and image) may be reduced organically according to a fitting algorithm that is similar to the one described above and executed by the screen-based index page creator 310 at block 550 in FIG. 5.

For some layouts, in order to reduce the size of an article, an image corresponding to an article may be cropped to fit within a certain region or area allocated for displaying or reproducing the particular layout. In some embodiments, images may be cropped according to one or more cropping heuristics. For example, since the most relevant or important aspects of an image typically are contained in the center of the image, one heuristic may be to crop the image around its center. Other heuristics could perform an algorithm to recognize one or more faces in an image and crop the image around the face(s) or another relatively interesting portion of the image.

Some images include captions. In some embodiments, image captions may be fitted or reduced separately from the image. For screen applications, clicking or tapping on an image that has been reduced or cropped may display the full-size original image with options to zoom.

As described above, the total space for an article may include the body text, which depends on the number and size of the columns used to display the body text. The space required for an article to be laid out on a page may also account for the space required for an advertisement within the article's region. Thus, content of the article may be fitted around predetermined allotted whitespace for advertising. In other embodiments, if the content of the advertisement is known, then the space for the advertisement may be sized appropriately for the content of the advertisement prior to fitting the article around the advertisement.

In certain implementations, the advertisements may include pay-per-click advertisements such that, if a reader clicks on the advertisement, more information about the advertisement will be displayed. Additionally or alternatively, if a web address or URL associated with the advertisement is available, the reader may be directed to the web address or URL when he or she clicks on the displayed advertisements. The advertisements may also be copies of the advertisements appearing in the original publication of the content source and modified to include an associated hyperlink that may be separately visible to the reader or embedded in the displayed advertisement itself.

The page layout creator 320 determines a size range for each article based on the minimum and maximum space that an article may occupy on one or more pages (block 640). At this point, the height and width dimensions of the canvas is known. In the present embodiment, each article occupies the entire horizontal width of the screen or page, but there is a range of possible sizes, or heights, for each article, depending on decoration applied to each layout and values of other typographic parameters. For example, there are minimum and maximum font sizes for the headline, minimum and maximum leading and kerning for the body text, minimum and maximum image sizes, etc. The minimum height of the entire article may be determined by applying the minimum values for each typographic parameter, and the maximum height of the article may be determined by taking the maximum values for each typographic parameter. The page layout creator 320 may adjust one or more typographic parameters to fit the article to a particular height within the range of possible heights.

The height of a page may be constant. If the page layout creator 320 adjusts the typographic parameters to set the height of an article equal to the height of a page, then an entire article may appear by itself on the page. If the height of an article is less than the height of a page, there will be “underflow.” The underflow is the amount of vertical space leftover on the page that may be filled by a different article or advertisement. If the height of an article is greater than the height of a page, there will be “overflow.” A portion of the article will occupy one or more full pages, and a final portion of the article will occupy a portion of a subsequent page. The overflow refers to the portion of the article that spills onto a portion of a subsequent page, leaving whitespace in the region of the page that is not occupied by the overflow. This whitespace may be filled by a different article or advertisement.

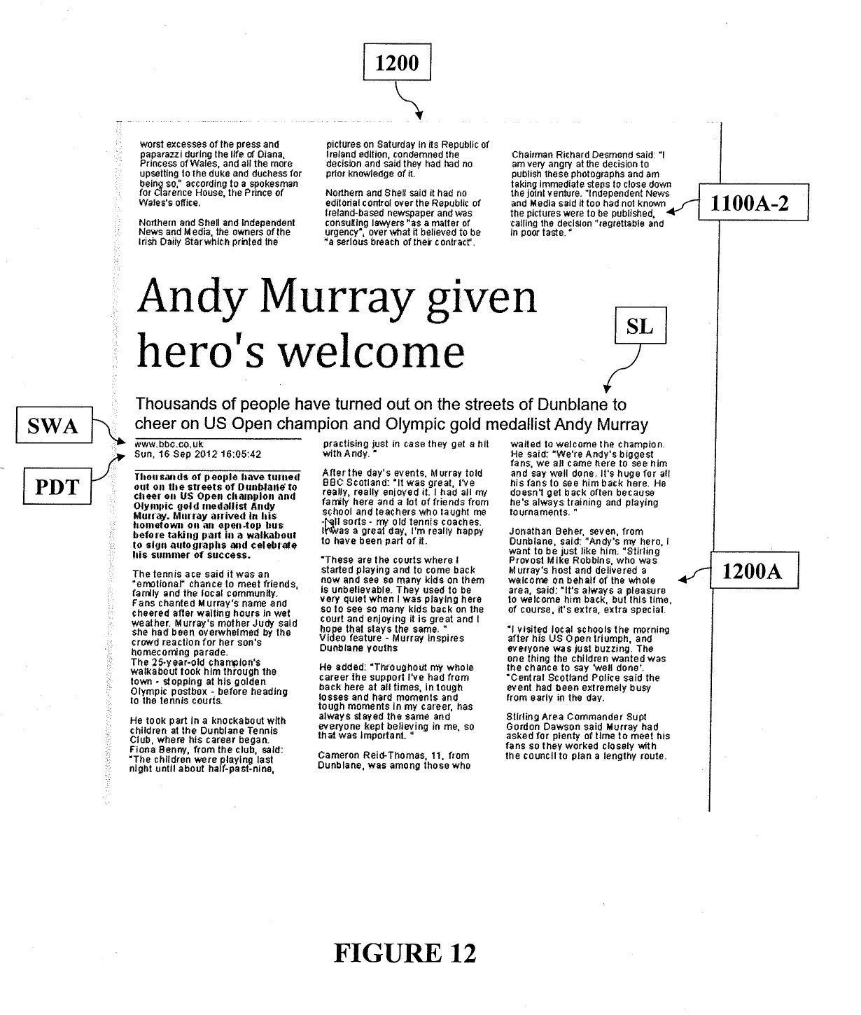

The page layout creator 320 then tries to arrange the order and layout of the articles on the pages to fill the whitespace gaps left by articles with underflow or overflow and conform to specified typographic features (block 650). This may be referred to as “matching” the articles. For example, for aesthetics, the creator 320 may require articles that do not start at the top of a page to end on that same page. Additionally, for aesthetics, the creator 320 may also have minimum underflow and minimum overflow requirements between successive pages. For example, a minimum overflow requirement may prevent very small portions of an article (e.g., one sentence) from overflowing or spilling over from one page onto the next page. A minimum underflow requirement may ensure that articles that do not fill a whole page leave sufficient space for a smaller, “filler article” or advertisement to fit completely within the remaining space on that page. For example, if a long article has an overflow that will occupy 20-40% of a subsequent page depending on its typographic parameters, the creator 320 may look for a matching filler article that may be laid out with an underflow between 20% and 40% that would correspond to, or match, the long article's overflow. FIGS. 12, 14, and 16 show examples of page layouts in which an article with underflow or overflow is matched with a filler article so that the pair of articles occupy a full page and thereby minimizing extraneous whitespace.

In some embodiments, in block 650, if matches are not available within the range of sizes for one or more articles (block 653: No), then the page layout creator 320 may adjust the page layout weightings associated with one or more articles (block 657). Adjusting the weightings provides for a different set of values for the typographical parameters to be applied to the articles. For example, the font size of the headline or the size of the image may be reduced. Then, the creator again decorates the articles according to one or more layouts (block 630), recalculates the new size ranges of the articles (block 640), and determines if the articles can be appropriately matched to the page (block 650).

If the articles can be matched (block 653: Yes), the page layout creator 320 may select the match from among the matches (block 660). In some embodiments, the selected match may be the match for which values of certain typographical features correspond most closely between the matched articles. For example, a match between two articles with the same leading (i.e., line spacing) is more aesthetically pleasing than a match between two articles with different leading. Because matched articles appear on the same page, it is more aesthetically pleasing if the matched articles on the same page have the same overall appearance due to having the same or similar values for various typographic parameters such as leading and kerning.

If all articles can be matched, the page layout may have minimum extraneous whitespace at the bottom of each page, and the sum of the sizes of all of the articles would correspond to an integer multiple of the size of the page (i.e., dimension of the canvas).

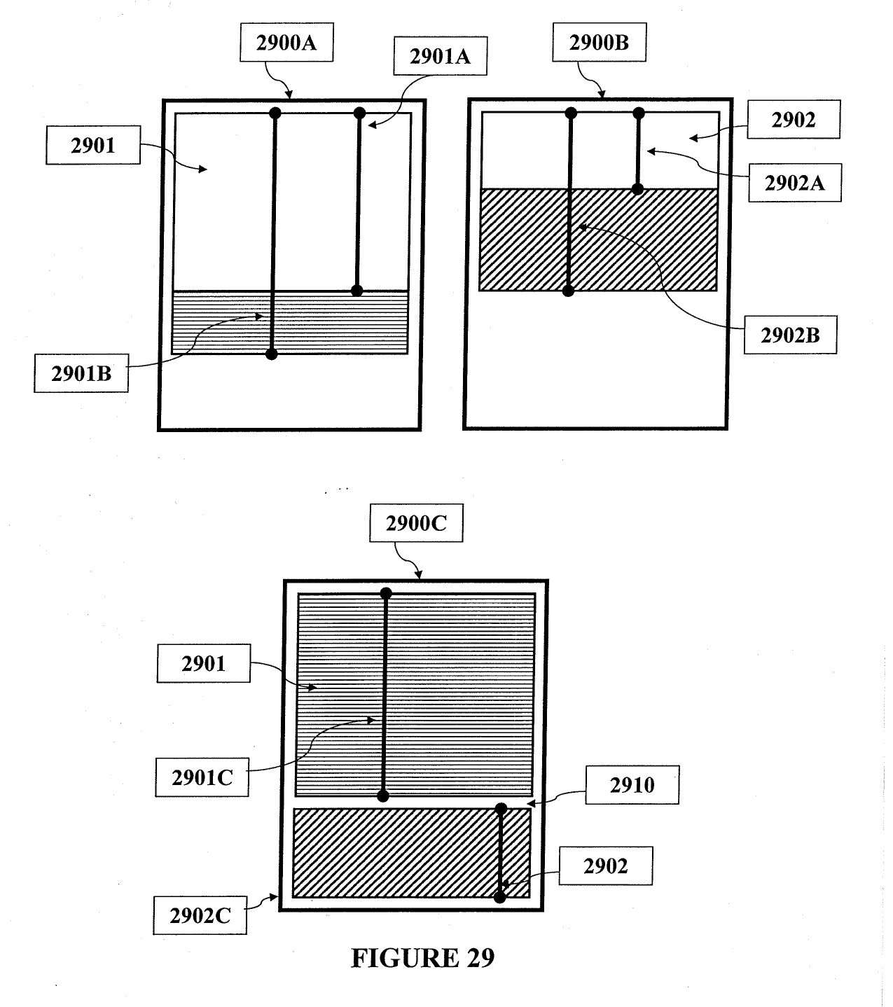

FIG. 29 shows an example of matching two articles according to a range of possible sizes. In this example, all of the articles span the entire width of the page, and thus, the size of the article can be represented solely by the height of the article. Of course, in other embodiments, the size of the article may be represented by the height of the article and one or more other dimensions, such as the width.

As shown in the figure, the article 2901 has a minimum height 2901A, which is the height of the article 2901A when the minimum values for the typographic parameters are applied. The article also has a maximum height 2901B, which is the height of the article 2901B when the maximum values for the typographic parameters are applied. If the article 2901 begins at the top of page 2900A as shown in FIG. 29, the page layout creator 320 can configure the article to have a size ranging between the minimum and maximum heights 2901A and 2901B by adjusting the values of one or more of the typographical parameters.

Similarly Article 2902 has a minimum height 2902A and a maximum height 2902B. If the article 2902 begins at the top of page 2900B as shown in FIG. 29, the creator 320 can also adjust its size to correspond to a height between the minimum and maximum heights 2902A and 2902B by appropriately changing one or more typographical parameter values between their respective minimum and maximum values. The creator 320 may determine that a good match exists for the articles 2901 and 2902 if their sizes can be adjusted within their possible ranges of sizes so that they can fit together on a page with a tight fit.

In the present embodiment, the article 2901 can be configured to a height 2901C, which is greater than the minimum height 2901A and less than the maximum height 2901B. Similarly, the article 2902 can be configured to a height of 2902C, which is between the minimum and maximum heights 2902A and 2092B. When the article 2901 has a height of 2901C and the article 2902 has a height of 2902C, they may be arranged on the same page 2900C and provide a tight fit (e.g., fit on the page with the optimal or nearly optimal amount of whitespace 2910).

While the example shown in FIG. 29 adjusts the sizes (e.g., heights) of the two articles 2901 and 2902 to tightly fit them together on a single page, the present disclosure is not limited to such an example. For instance, in other embodiments, the minimum and maximum heights of a first article may span two pages, and the minimum and maximum heights of a second article may be smaller than the height of one page. In this instance, the sizes of the articles may be adjusted so that they fit tightly across two pages. Namely, after the sizes of the articles are adjusted, an initial portion of the first article may occupy one page, and an overflow portion of the first article may occupy an area of a subsequent page. The subsequent page may also contain the entire second article so that the overflow portion of the first article and the entire second article fit snuggly on the second page. In yet another embodiment, in some scenarios, adjusting the size of only one of the articles may be performed to tightly fit two or more articles on a page (or across multiple pages).

For screen-based applications, such as an Apple iPad tablet 212, a user may rotate the device to switch between portrait and landscape orientations. Thus, as noted above in the explanation of the method 400 (FIG. 4) performed by the screen-based index page creator 310, the page layout creator 320 may generate both portrait and landscape page layouts. In some embodiments, the portrait and landscape page layouts may be correlated. For example, there may be a rule that the order in which articles appear should remain the same when the orientation of the device changes. There may be another rule that articles matched together in landscape orientation should also be matched together in portrait orientation. In another example, the relative positions of headlines, images, and other content should be the same in both orientations. Rules such as these help maintain a consistent reading experience for users when they change the orientation of their devices.

To satisfy these rules, the creator 320 may determine when the dimensions of the canvas may be inverted, such that the height in one orientation becomes the width in another orientation, and vice versa. When decorating layouts and matching articles, the creator 320 may check whether a particular decoration or match fits both orientations, so that the decoration and match will be the same even if the orientation of the device changes. After the appropriate match is selected in block 660, the method 600 ends (block 670).

FIG. 7 shows a more detailed example of a method 700 that the body column creator 330 performs in block 450 (FIG. 4) to format, into one or more columns, both the article previews for the index page (created by the screen-based index page creator 310) and the entire articles for the printed or screen pages (laid out by the page layout creator 320). Moreover, in addition to being performed in conjunction with the typographic electronic pagination method 400 described above, the method 700 may be performed as a standalone process.

After the method begins (block 710), the creator 330 identifies “points of interest” (block 720). Points of interest may be an element or part of an element so that columns of text may be aligned to the points of interest. In one implementation, points of interest may be certain article elements or placeholders for article elements within a selected page layout or article preview. For example, the space occupied by the headline, strapline, image, and other details may be points of interest that should be identified. Regions of the page allotted to advertisements may also be identified as points of interest. In the present example, the body column creator 330 performs the method 700 to fit one or more columns of body text around the points of interest in a visually appealing manner that conforms to typographical standards or conventions. One example of fitting a column around a point of interest is “snapping columns” to align with one or more corners of an image. In FIG. 13, the left side of the center column of the article 1300A-1 is aligned with the bottom left corner (i.e., point of interest) of the image, and the right side of the rightmost column of the article 1300A-1 is aligned with the bottom right corner (i.e., point of interest) of the image.

In other embodiments, points of interest could be bounding areas for anything that can be displayed on a screen or printed. For example, points of interests could be for objects such as video or interactive content, such as Flash applications or other elements. These objects may have rectangular boundaries or boundaries of regularly or irregularly shaped polygons or curves. The headline, body, and other text of the articles or previews, as well as the images, are fitted around the objects.

As part of fitting the text and images around the objects, the body column creator 330 adjusts the size of the columns of the text (block 730). For example, the creator 330 may adjust various typographic features, such as the margins between the column text to the edges of the pages or the margins between the column text and the headline, strapline, image, caption, or advertisement of an article. If there is more than one column of text, then the size of the columns (or space that they occupy) may be adjusted by changing the width of the gutter or gutters (i.e., whitespace) between columns.

In addition to changing the size of the columns, the body column creator 330 may adjust the number of columns (block 740). For example, the number of columns for displaying an article or preview may be increased from two columns to three columns or decreased from two columns to one column to better fit the article or preview on the page.

Adjusting the size of the columns (block 730) and the number of columns (block 740) provides greater flexibility in sizing the article or preview between a minimum size (occupying a relatively small space on the page(s)) and a maximum size (occupying a relatively large space on the page(s)), as well as its relative orientation among other articles or previews, while enabling the article or preview to still be displayed in a visually pleasing manner. This added flexibility enhances the ability of the ePagination Server 110 to adequately fit a number of articles or previews onto one or more pages. For example, for each additional column added, an additional adjustable gutter of whitespace is added between the columns. With more total whitespace per line, fewer words per line may fit within each of the columns, and thus, the total space required for the article or preview increases as the number of columns increases and the width of the gutters between the columns increases.

The body column creator 330 may also make additional adjustments. For example, text may be hyphenated automatically. The alignment of the text, such as left justification or full justification, may also be adjusted. The range of acceptable adjustments may be determined according to specified typographic parameters. For example, a minimum column height, a range of allowed words per line, a range of column widths and gutter sizes, a maximum difference in column height (e.g., column 2 must be at least 90% as tall as column 1), or maximum image width that should align with the column widths may be set. These parameters may be input by a user of the ePagination Server 110, be predetermined based on data provided by the content providers of the sources 201-205, or be set automatically to default values.

After the size and number of columns have been adjusted in blocks 730 and 740, the body column creator 330 determines whether the columns provide a fit for the body text around the identified points of interest that exceeds a threshold fitness (block 750). If the columns do not fit (block 750: No), the size and/or number of columns are readjusted (blocks 730 and 740), and the creator determines if the readjusted columns fit (block 750). If the columns fit (block 750: Yes), the method 700 ends (block 760).

The discussion below contains more detailed examples of the operation of, and screens and pages generated by, the screen-based index page creator 310, the page layout creator 320, and the body column creator 330 of the ePagination Server 110.

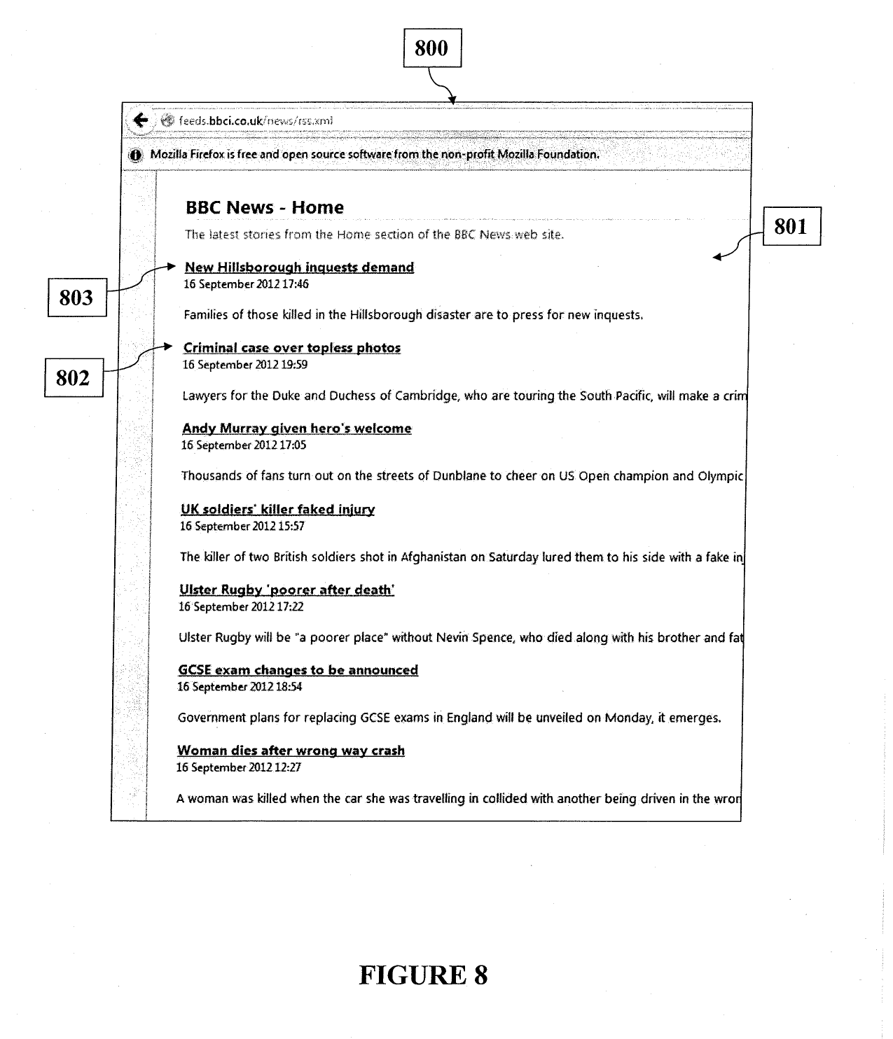

FIG. 8 shows an example of unformatted data that the ePagination Server 110 may receive. In this embodiment, an RSS newsfeed 801 from the British Broadcasting Corporation (BBC) is rendered in a web browser 800. The newsfeed 801 may contain plain text XML files, and in the present example, an item 802 is rendered with a hyperlinked headline (i.e., “Criminal case over topless photos”), publication date (i.e., Sep. 16, 2012), and the beginning of the article text (i.e., “Lawyers for the Duke . . . ). In the newsfeed 801, the first item 803, with the headline “New Hillsborough inquests demand” is considered to be the lead article.

FIG. 9 shows an example of a screen-based index page 900 that the screen-based index page creator 310 (FIG. 3) generates in accordance with the illustrative method 500 (FIG. 5) described above. The creator 310 creates the index page 900 having five article previews 900A-900E based on the content of the RSS feed 801 in FIG. 8.

As shown, the article preview 900A corresponds to the lead article 803 in FIG. 8 and appears in the upper-left position of the page 900. The preview 900A contains a headline 901, an image 902, and a strapline 903. Since preview 900A corresponds to the lead article 803, its headline 901 is the largest headline relative to the other headlines, and its image 902 is the largest image relative to the other images. The strapline 903 of the article 803 appears bolded below the image. The preview 900A also includes article preview text 904, which is the first portion of the text of the lead article 803 and includes several complete sentences. The other article previews 900B-900E on the index page 900 have lower relative visual weightings than the preview 900A for the lead article 803. Thus, they have smaller headlines, smaller images, and/or less article preview text.

As noted on the index page 900, the preview texts of the article previews 900A and 900C-900E are arranged in one column, whereas the preview text 910 of the article preview 900B is arranged in two columns. The body column creator 330 set the number of columns of the previews 900A-900E during its performance of the method 700 (FIG. 7) so that the article previews 900A-900E fit together snuggly on the index page 900 in an aesthetically pleasing manner. In addition, in performing the method 500 (FIG. 5), the screen-based index page creator 310 selected the portions of the preview texts for respective previews 900A-900E such that each of the preview texts ends with a full stop (i.e., is a complete sentence).

Additionally, the index page 900 contains a newspaper logo 915, a border 920 around the perimeter margins of the page 900, and vertical borders 930 separating the article previews 900A-900B on the left side of the index page 900 from the previews 900C-900E on the right side. In one embodiment, the creator 310 creates the logo 915 and the borders 920 and 930. The dimensions of index page 900 may be fixed or may be arbitrary and adjustable to suit different sizes of printed pages or screen-based applications.

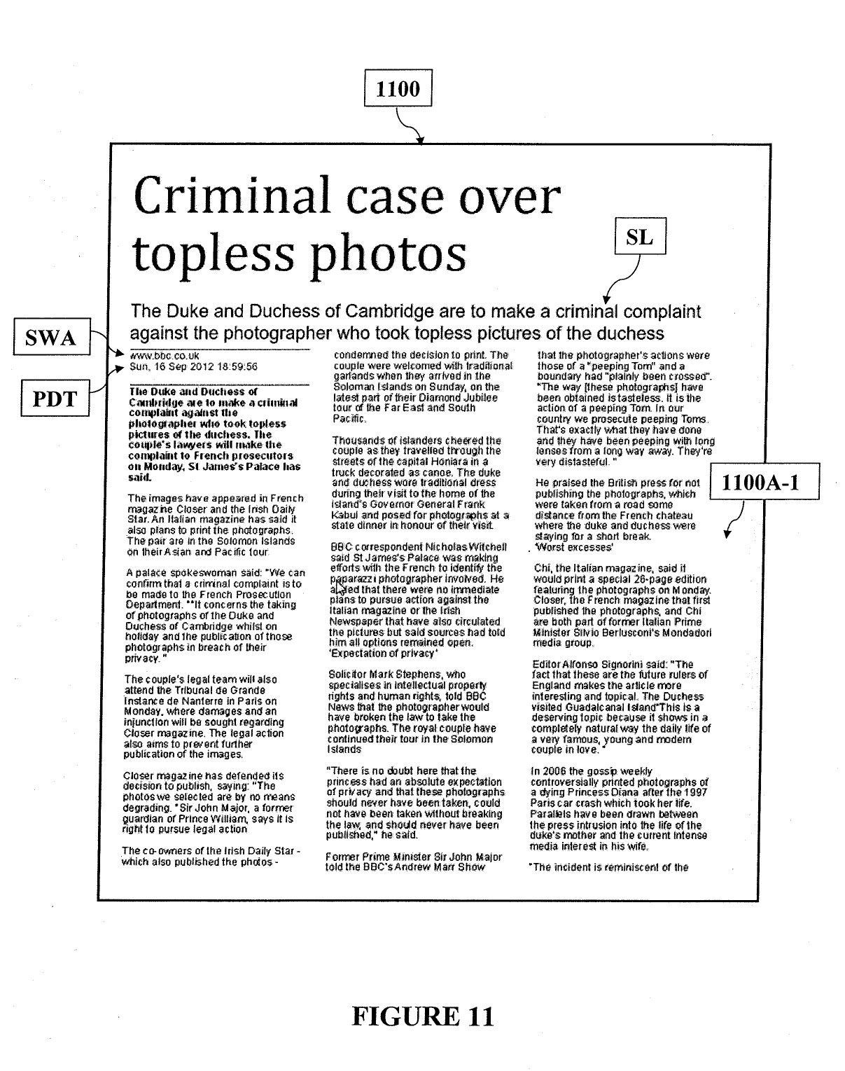

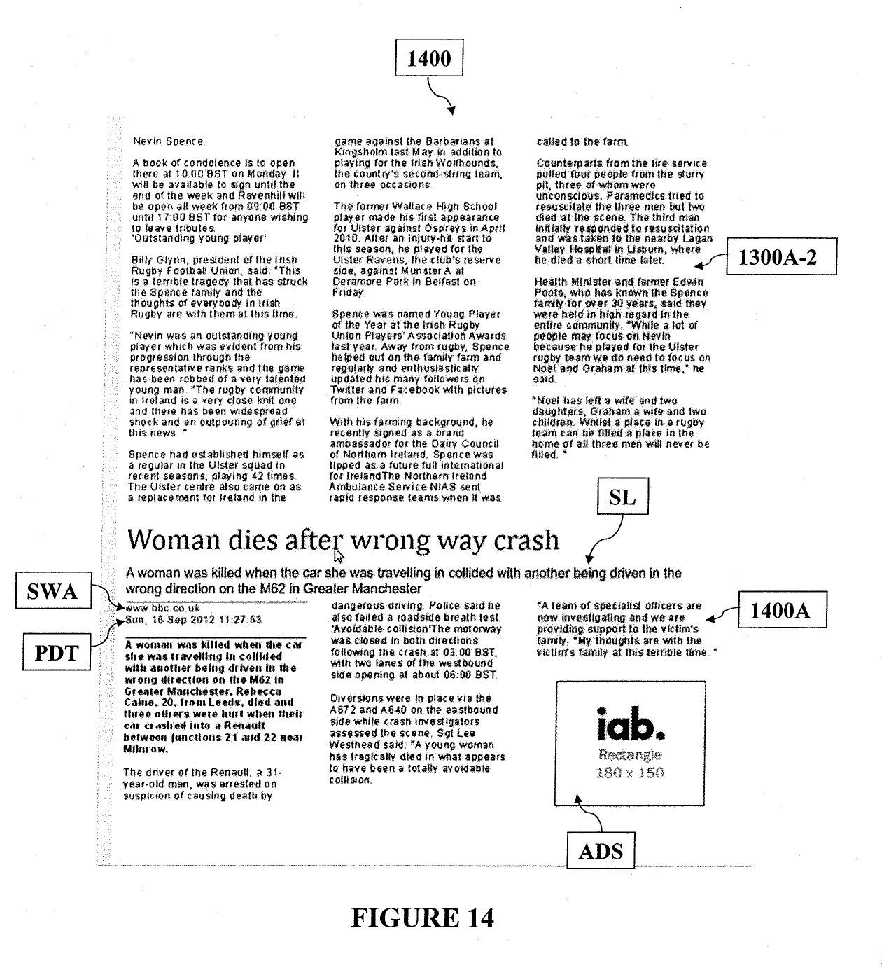

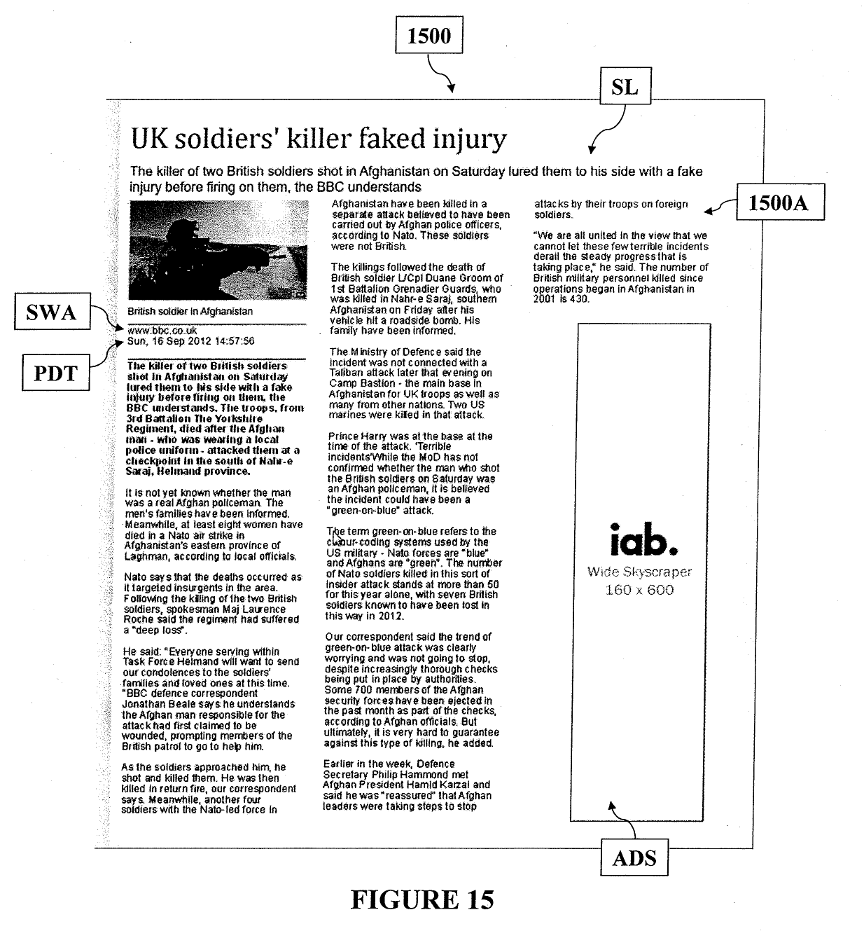

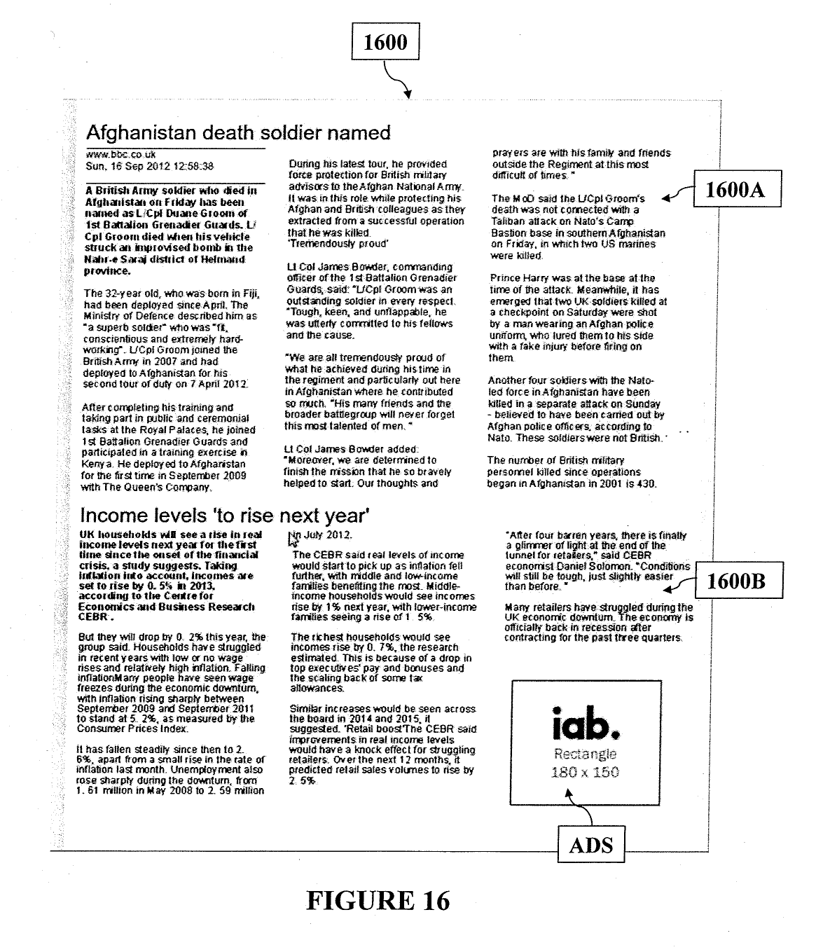

FIGS. 10-16 show an example of a series of pages 1000-1600 generated when the page layout creator 320 performs the method 600 (FIG. 6) on the newsfeed 801. As shown, the pages 1000-1600 include articles 1000A, 1100A, 1200A, 1300A, 1400A, 1500A, 1600A, and 1600B. Specifically, the first page 1000 (FIG. 10) contains a first article 1000A in its entirety. The second page 1100 (FIG. 11) contains a first portion 1100A-1 of the second article 1100A, and the third page 1200 (FIG. 12) contains a second portion 1100A-2 the second article 1100A. The third page 1200 also contains the third article 1200A in its entirety. The fourth page 1300 (FIG. 13) contains a first portion 1300A-1 of the fourth article 1300A, and the fifth page 1400 (FIG. 14) contains a second portion 1300A-2 the fourth article 1300A. The fifth page 1400 also contains the fifth article 1400A in its entirety. The sixth page 1500 (FIG. 15) contains a sixth article 1500A in its entirety, and the seventh page 1600 (FIG. 16) contains the seventh article 1600A and the eighth article 1600B in their entireties.

Upon comparing the index page 900 (FIG. 9) with the pages 1000-1600 (FIGS. 10-16), one notes that many of the articles on the pages are previewed on the index page 900. Namely, the article preview 900A on the index page 900 corresponds to the first article 1000A (FIG. 10). The article preview 900D corresponds to the second article 1100A (FIGS. 11 and 12), and the article preview 900E corresponds to the third article 1200A (FIG. 12). The article preview 900B corresponds to the fourth article 1300A (FIGS. 13 and 14), and the article preview 900C corresponds to the sixth article 1500A (FIG. 15). In some embodiments, the page layout creator 320 may create page layouts for articles such as minor articles that do not appear on the index page. For example, the articles 1600A and 1600B (FIG. 16) do not appear on the index page 900.

As noted above, the article preview 900A corresponds to the lead article 803 received first in the RSS newsfeed 801 (FIG. 8) from the BBC, and thus, the preview has the highest visual weighting in the index page 900. The article preview 900D corresponds to the second article 802 received in the newsfeed 801 and has the second highest visual weighting. The remaining article previews 900B, 900C, and 900E, which corresponds to the subsequently received articles, have the lowest visual weighting.

Since the previews 900A and 900D have higher weightings than the other previews 900B, 900C, and 900E, the page layout creator 320 tries to locate the full articles corresponding to these previews 900A and 900D on the initial pages of the page layout if it can do so while conforming to typographic standards or conventions and while maintaining an aesthetically pleasing layout. In the present example, the creator 320 is able to position the full articles 1000A and 1100A (corresponding to the previews 900A and 900D) on the first three consecutive pages 1000-1200 of the page layout.

Moreover, since the first article 1000A (FIG. 10) corresponds to the preview 900A with the highest weighing and the lead article 803, the page layout creator 320 similarly assigns a “Main” weighting to the article 1000A in the page layout. Thus, the headline, strapline, and other elements of the article 1000A may have the largest size relative to the other articles in the page layout. Similarly, since the preview 900D has the second highest visual weighting, the creator 320 may assign a “General” weighting to the corresponding article 1100A (FIGS. 11 and 12) in the page layout. Thus, the headline, strapline, and other elements of the article 1100A may have a smaller size than those of the article 1000A with the “Main” weighting, but may have a larger size than the remaining articles 1200A-1600A (FIGS. 12-16). Since the remaining articles 1200A-1600A in the page layout correspond to previews 900A, 900C, and 900E with low weighting, or do not even correspond to a preview on the index page 900, the creator 320 may assign these articles 1200A-1600A with a “Minor” weighting. Thus, the remaining articles 1200A-1600A may be assigned a “Minor” weighting and have article elements that are smaller than those of the article 1100A.

The page layout creator 320, in conjunction with the body column creator 330, work together to adjust the sizes of the articles 1000A-1600B so that they can be laid out on the screens or pages in an aesthetically pleasing manner and in conformity with typographical standards or conventions. For instance, the page layout is more visually appealing if the pages 1000-1600 have little or no extraneous whitespace. One typical area where whitespace is difficult to eliminate is the area between the last sentence of the last article 1600B of the layout and the bottom margin of the last page 1600. However, as shown in FIG. 16, by properly adjusting the sizes of the articles 1000A-1600B and by using other techniques, the page layout creator 320 is able to layout the articles 1000A-1600B so that there is little or no whitespace between the end of the last article 1600B and the bottom of the page 1600.

Many of the techniques that the page layout creator 320 and the body column creator 330 use to adjust the size of the articles has been described above, and some of the techniques are explained below. One example of a size adjusting technique is to selectively include article elements (images, straplines, etc.) in, or omit article elements from, the articles 1000A-1600B.

For instance, as shown in FIGS. 10-12, 14, and 16, the sizes of the articles 1000A-1200A, 1400A, 1600A, and 1600B are reduced by omitting images from them. Moreover, although articles 1000A-1500A include straplines SL, source web addresses (or URLs) SWA, and publication dates and times PDT, the creator 320 omitted straplines from the articles 1600A and 1600B to reduce their size. Alternatively, the creator 320 may be configured to prevent image(s) from being omitted from the created page layouts.

In addition, in the present embodiment, the body column creator 330 has organized the text of the articles 1000A-1600B into three columns and adjusted the spacing between the columns, as well as the spacing between the columns and other article elements, to resize the articles 1000A-1600B. While the text of all of the articles 1000A-1600B is organized into three columns in this example, of course, the creator 330 can organize the text of one, more, or all of the articles 1000A-1600A in to a different number of columns so that the articles can be adjusted to have the appropriate size.

Another technique that the page layout creator 320 uses to increase the size of an article so that all of the articles fit snuggly across all pages of the layout is to add advertisement spaces ADS to the articles. In one embodiment, the page layout creator 320 inserts advertisements into these spaces ADS, and in another embodiment, another device (which may be part of or external to the ePagination system) may insert advertisements into the spaces ADS. In the present embodiment, the creator 320 has added advertisement spaces ADS to the articles 1000A, 1300A-1500A, and 1600B as shown in FIGS. 10 and 13-16. Moreover, to provide greater flexibility in resizing the articles, the creator 320 can select from among a plurality of differently sized spaces ADS to insert into the articles. The different sizes of the spaces ADS may be fixed or adjustable. In some embodiments, the creator 320 may be configured to require that specific advertisements must be present in created layouts. The creator 320 may be further configured to require that the specific advertisements be of a certain size. For example, an advertiser may pay for an advertisement associated to span the full width of a page on which a article with a Major page layout weighting appears, and the creator 320 may be required to insert the purchased advertisement.

In some embodiments, other techniques for resizing articles in a way that preserves their visually appealing characteristics is to ensure that various elements of the articles are aligned when they are resized with respect to each other. For example, when the page layout creator 320 adjusts the size of an image of an article, it resizes it so that its width corresponds to the width of one or more columns of texts. FIG. 13, for instance, shows a scenario in which the page layout creator 320 decreased (or increased) the size of an image of the article 1300A while ensuring that its width corresponds to the width of two columns (taking into account the gutter space between the columns). Moreover, to maintain the aesthetics of the article, the creator 320 aligned the left side of the image with the left side of the middle column. To further enhance the visual appearance of the article 1300A, the creator 320 likewise aligned the top portion of the image with the top of the source web address SWA in the first column.

Similarly, in the article 1500A shown in FIG. 15, the page layout creator 320 adjusted the size of the image by cropping the image so that its width corresponds to the width of one column of text. Moreover, the creator aligned the left edge of the image with the left edge of the left column.

The page layout creator 320 and the body column creator 330 also create the page layouts such that they conform to various typographical conventions. For instance, one convention is that, if an article does not start at the top of a page, it must end on the same page. This article, which is a filler article, must fit entirely on a single page to conform to this convention. Under this convention, longer articles that overflow onto additional pages should start at the top of the page. The filler article should start below the overflow portion, and the filler article itself should not overflow onto a later page. FIGS. 11 and 12 illustrate one example of how the creator 320 satisfies this design guideline or convention. Namely, since the article 1100A is too large to fit on a single page, the page 1100 can only contain the first portion 1100A-1 of the article 1100A, and the second portion 1100A-2 spills over, or overflows, onto the next page 1200. Due to this overflow, the next article 1200A cannot start at the top of the page 1200 and instead starts about one-third of the way down the page. As such, the page layout creator 320 selects and resizes the article 1200A so that it ends at the bottom of the page 1200, as opposed to overflowing onto the next page 1300 or ending prior to the bottom of the page 1200.

Similarly, in FIG. 14, since the article 1400A does not start at the top of the page 1400, the page layout creator 320 selects and sizes the article 1400A so that it ends at the bottom of the page. The article 1600B in FIG. 16 shows yet another example of the creator 320 conforming to this typographical convention.

Another design guideline to make articles aesthetically pleasing is to group the text into a certain number of columns and size the vertical dimension of the article so that the bottom of all of the columns are aligned. Other techniques to align the bottom of the columns of an article is to insert other article elements (e.g., an image or an advertisement) above or below the text of one or more of the columns. For example, as shown in FIG. 13, the article 1300A has three columns, and an image is inserted above the text of the two rightmost columns to help ensure that the bottom edges of all three columns are aligned. Similarly, in FIG. 14, the article 1400A has three columns, and an advertisement ADS is inserted below the text of the rightmost column to assist in aligning the bottom edges of all three columns. (In this example, the bottom edge of the advertisement ADS corresponds to the bottom edge of the rightmost column). The article 1500A in FIG. 15 shows a similar example, in which an image is inserted above the text of the leftmost column and an advertisement ADS is inserted below the text of the rightmost column to align the bottom edges of the columns.

In some embodiments, requiring the bottom edges of the columns of an article to precisely align may be too rigid of a rule. Thus, the page layout creator 320 and/or body column creator 330 may consider columns to be aligned if there edges are within a maximum permissible distance of each other. For example, in FIG. 14, the rightmost column of the second portion 1300A-2 if the article 1300A is shorter than the bottom of the leftmost and center columns. However, since the bottom edge of the rightmost column is within a vertical threshold distance of the leftmost and center columns, the creator 320 and/or 330 considers the columns to satisfy this requirement.

Another typographical convention applies when a page contains two articles or at least portions of two articles. In this instance, making widths of the columns of the two articles (or portions) and spacing between the columns to be the same enhances the aesthetics of the page.

However, as with the previous convention, applying this rule too rigidly may hinder the ability of the page layout creator 320 and/or the body column creator 330 to generate the page layouts appropriately. For example, in FIG. 16, the page 1600 contains two articles 1600A and 1600B. As shown, the width and spacing of the columns in the article 1600A are different from the width and spacing of the columns in the article 1600B. Nonetheless, since the widths and spacings are within predetermined thresholds of each other, the creator 320 and/or 330 considers the columns of the articles 1600A and 1600B to be similarly sized and spaced.

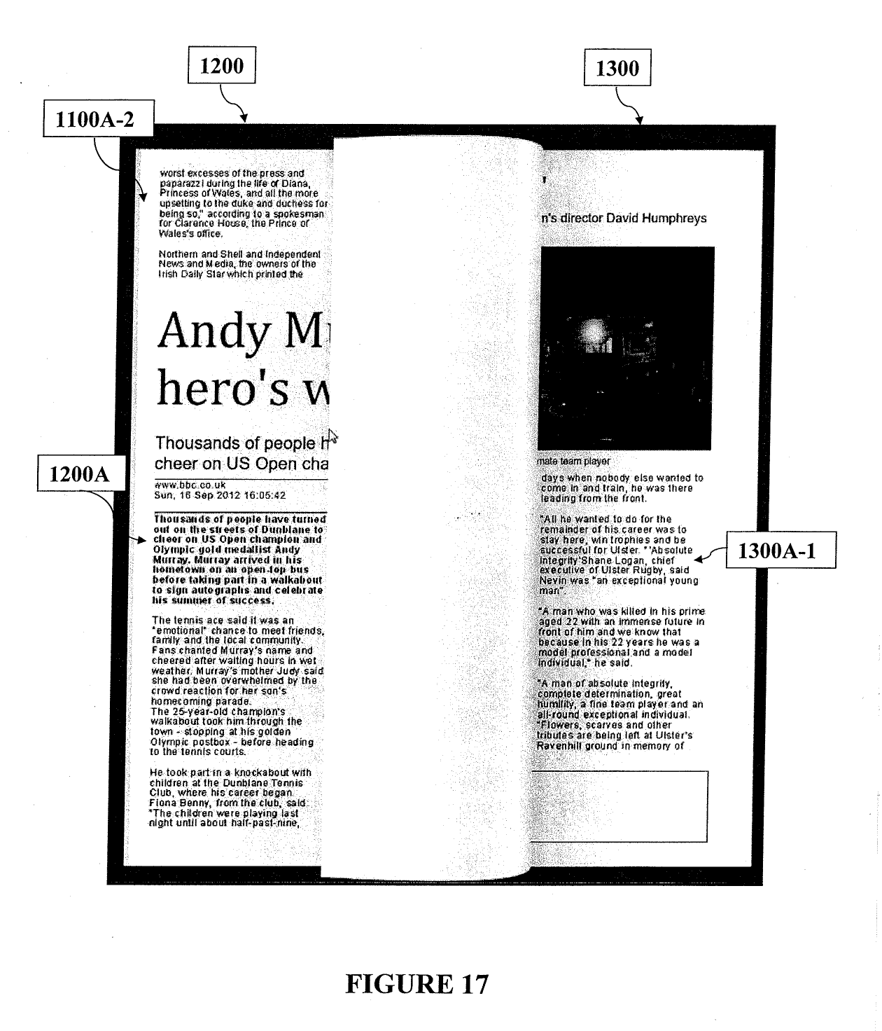

In some embodiments in which the page layout is displayed on a screen, the page layout creator 320 may create the layout so that a reader can manipulate a user interface, such as a touch screen, to flip through the pages in a manner that simulates turning the pages of a hardcopy book or newspaper. For example, FIG. 17 shows an example of a tablet 212 that displays the page layout containing the pages 1000-1600 shown in FIGS. 10-16. If the reader is displaying page 1200 of the layout, he or she can move a finger or other device in a leftward direction across the tablet 212. In response to this instruction, the tablet 212 displays an animation that simulates the turning of page 1200 to show the next page 1300.

The ePagination Server 110 may contain a number of default, predetermined, or configurable typographic parameters. These parameters may affect the overall aesthetic or look-and-feel of an output publication or layout and may help ensure typographic correctness. These parameters may define single values, or they may define ranges of acceptable values or tolerances. The typographic parameters described herein should not be considered an exhaustive list but are merely examples provided for illustrative purposes.

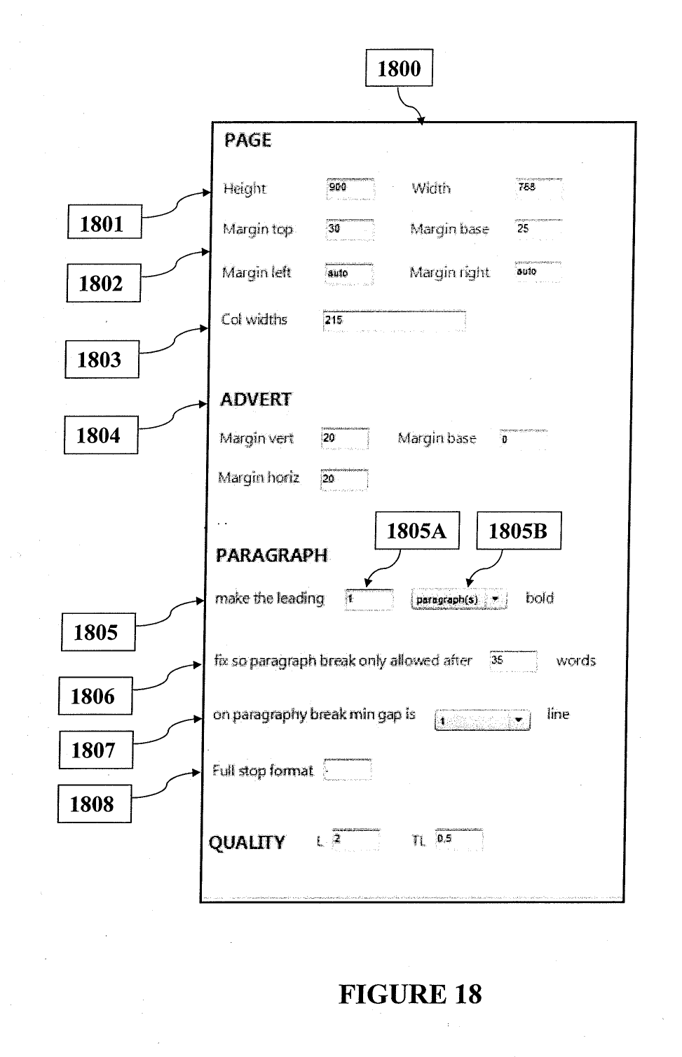

FIG. 18 shows one embodiment for inputting typographic parameters and settings that may be used by the page layout creator 320. As shown, ePagination Server 110 may control a display to display a panel 1800 prompting a user to input or modify various typographic parameters. Initially, the panel 1800 may contain default values for the parameter and/or may be configured by a content provider, an ePagination system administrator, or other user.

The first portion of panel 1800 contains parameters related to characteristics of an article page layout. For example, the parameters may include height and width parameters 1801 that define the dimensions of the canvas for print or screen-based applications. In some embodiments, the dimensions may be defined by pixels, and in other embodiments, the dimensions may be defined by centimeters or other unit of length.

The parameters may also include margin parameters 1802 that specify the amount of whitespace between the text, image, etc. of an article and the top, base (i.e., bottom), left, and right edges of the page or screen. The margins can be set to specific values corresponding to length or number of pixels. Additionally, some or all of the margins (e.g., the left and right margins) can be set with an “auto” parameter so that their sizes adjust automatically. Dynamically adjusted margins provide a greater range of width or height for article content that will allow for an article to fit snuggly within a page.

The second portion of the panel 1800 contains advertisement parameters 1804. These parameters 1804 specify the amount of whitespace between article text and regions allotted to advertisements and operate in a manner similar to the margin parameters 1801-1802 discussed above.

According to some embodiments, the ePagination Server 110 may receive source articles that are unformatted, or formatted inconsistently, or formatted in a way that varies from the desired style for a particular output layout. Several typographic parameters may impose formatting onto the text of the articles to conform to a desired style or predetermined typographic layout for the output layouts.

For example, the third portion of the panel 1800 contains typographic parameters pertaining to paragraph formatting. For example, a bolding parameter 1805 specifies the amount of text, if any, which should be bolded at the beginning of an article. In one implementation, by inputting a non-negative integer in the window 1805A and selecting the appropriate menu selection (e.g., paragraph, sentence, etc.) from the drop down menu 1805B, a content provider or a user of the ePagination system may specify, for example, that the system should “make the leading 1 paragraph(s) bold,” “make the leading 2 sentence(s) bold,” or other style configurations.

In another example, the paragraph word break parameter 1806 ensures that paragraphs are not truncated on a page or break across pages such that only a small portion of a paragraph remains on a page. Allowing only a few words or lines of a paragraph to remain on a page detracts from the aesthetics of the page. A content provider or user can input a number for this parameter 1806 to ensure that only portions of a paragraph having more than the specified number of words are allowed to remain on a page. In the example shown in FIG. 18, the user inputs “35” as the parameter 1806 to instructs the page layout creator 320 to only truncate a paragraph on a given page or allow it to break across the given page and a subsequent page after 35 words are contained on the given page. Of course, the user can effectively disable this feature by setting paragraph word break parameter 1806 to “0”. The paragraph line break parameter 1807 is similar to the parameter 1806, except that it specifies the number of lines of a paragraph that must remain on a given page when it is truncated or breaks across the given page and a subsequent page.

In another example, the full stop format parameter 1808 allows a content provider or user to specify certain punctuation or other symbols or formats that represent a full stop or a complete sentence. In some embodiments, any full stop format such as a full stop or period, exclamation point, or question mark may indicate the end of a complete sentence. This parameter may also specify how many spaces should appear between sentences (e.g., one or two spaces).

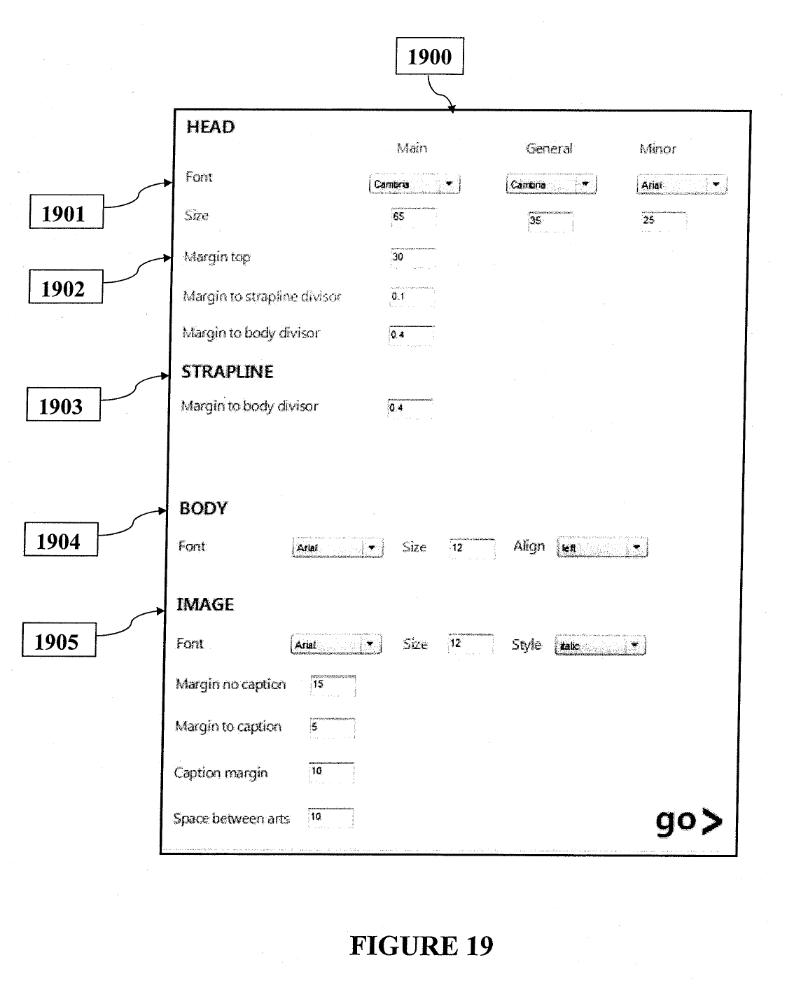

FIG. 19 shows one embodiment for inputting typographic parameters and settings that may be used by the page layout creator 320. As shown, ePagination Server 110 may control a display to display a panel 1900 prompting a user to input or modify various typographic parameters. The first portion of the panel 1900 contains parameters related to headlines. For instance, headline font parameters 1901 allow a user to specify the font for headlines, and the font may be different for articles with different weightings. In the example shown, headlines with “Main” and “General” weightings have a Cambria font, whereas headlines with a “Minor” weighting have an Arial font. These parameters 1901 also allow a user to specify the font size of the headlines, which may be different depending on the weighting. For example, headlines with “Main,” “General,” and “Minor” have font sizes of 65, 35, and 25, respectively, as shown.

The panel 1900 also includes headline margin parameters 1902. These parameters 1902 specify the relative distances from the headline to the top of the page, from the strapline to the top of the page, and from the body text of the article to the top of the page. The distance between the top margin to strapline and top margin to body may be represented by divisors of the headline font size. For example, the bigger the font size of the headline, the greater the distance between top margin and the headline. The margin to body divisor of the headline margin parameters 1902 specifies the divisor or ratio of distance between the headline and article body text for articles where the strapline is not rendered. Similarly, strapline margin parameter 1903 specifies the divisor or ratio for the distance between the strapline and the article body text for articles where the strapline is rendered.

The panel 1900 also includes image parameters 1905 that specify properties related to images and image captions on the page layout. For example, these parameters 1905 may specify the font type (e.g., Arial) for the caption of the image, the font size (e.g., 12) of the caption, and the font style (e.g., italics) of the caption. The “Margin no caption” parameter specifies the distance (i.e., whitespace) between the image and the article body text when a caption is not rendered, whereas “Margin to caption” specifies the distance between the image and the caption when the caption is rendered. “Caption margin” specifies the distance between the caption and the article body text when the caption is rendered. “Space between art[icle]s” specifies the distance between the end of a first article and the headline of a filler article that appears below the first article.

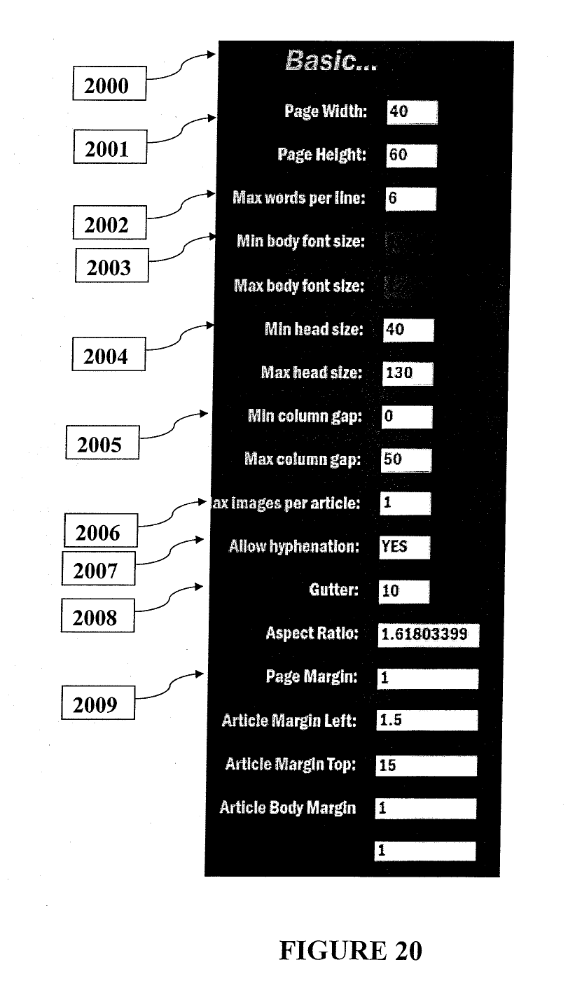

FIG. 20 shows an embodiment for setting typographic parameters and other settings for the screen-based index page creator 310. In the embodiment, the ePagination Server 110 may control a display to display a panel 2000 prompting a user to input or modify various “basic” typographic parameters for index pages. The parameters include index page dimension parameters 2001 that specify the width and height of the index page or screen, which may be the same or different from the dimensions of the article page layouts described above. Moreover, as mentioned previously, the width and height can be specified based on a number of pixels or by units of length.

The panel 2000 contains an maximum headline words per line parameter 2002 that specifies the maximum number of words that can appear in a single line of a headline on the index page. This parameter helps ensure that the number of words in each line of one headline on the index page are balanced with the number of words in each line of the remaining headlines on the page. This balance creates a more visually appealing index page.

Other parameters include body font size parameters 2003, headline size parameters 2004, and column gap parameters 2005. The body font size parameters 2003 specify the minimum and maximum font size for the text in the body of the article previews appearing on the index page. The headline size parameters 2004 specify the minimum and maximum font sizes for the headlines on the index page. The column gap parameters 2005 specify the acceptable range of differences in height (i.e., vertical length) between two columns in the same article preview.

The panel 2000 also contains a maximum images per article parameter 2006 that specifies the maximum number of images that may appear for each article on the index page. For example, some content sources may include multiple images for a single article, and the content provider may specify more than one image per article for the index page. This parameter 2000 limits the number of images displayed on the index page for each article preview to prevent the index page from appearing overcrowded.

The index page “Allow hyphenation” parameter 2007 specifies whether words may break at syllables across lines with a hyphen. Hyphenation enables more words and parts of words to fit across a single line of text, so the total space required for an article may be reduced. Some designers disable hyphenation because they consider it to detract from the readability and typographical aesthetics of a layout. Similarly, the gutter parameter 2008 specifies the amount of whitespace between columns of text on an index page and, therefore, affects the number of words that fit across each line of text. The index page margin parameters 2009 specify the margins around the perimeter of the index page and the margins around the perimeter of each article preview.

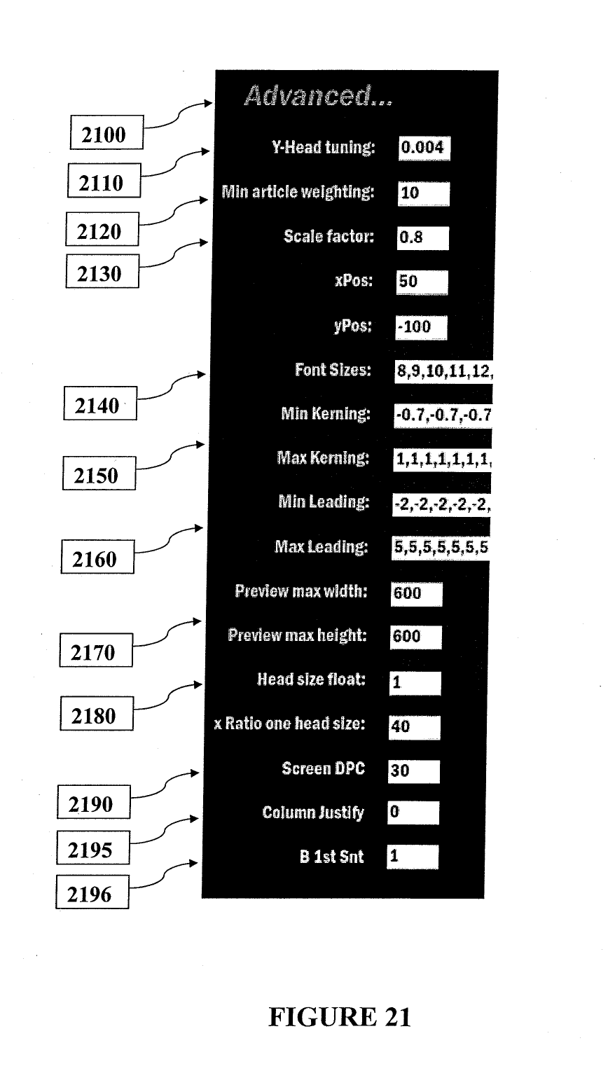

FIG. 21 shows an embodiment of a panel 2100 that may be displayed to enable a user to input various “advanced” typographic parameters and settings for screen-based index pages. The panel 2100 includes a Y-Head tuning parameter 2110 that specifies how much the size of a headline should be increased to compensate for appearing in a position lower on the index page. For example, if two articles previews are both weighted the same amount (i.e., 30%) and have the headlines with the same size, the headline for the article preview positioned lower on the page may, due to an optical illusion, appear to be smaller. Therefore, to give the visual impression that both headlines are the same size, the size of the lower headline of the article preview positioned lower on the index page is increased slightly. The Y-Head tuning parameter 2110 determines how much the size of the headline is increased.

The minimum article weighting parameter 2120 specifies the minimum relative visual weighting that any given article preview can have. In the example shown in panel 2100, the minimum article preview weight is 10%. In this case, it would not be possible for a lead article to have a weighting of 95% while a second article has a weighting of only 5%.

Index page scale factor parameter 2130 specifies how much articles may be reduced in each iteration or reduction step. For example, an image may be reduced 5% per reduction, or 10% per reduction, or 15% per reduction. Lower page scale factor parameter values may result in a tighter fit by making more fine-tuned reductions, whereas higher page scale factor parameter values may decrease the time needed to generate a layout with a good fit by reducing the total number of iterations.

The panel 2100 also includes font sizes parameters 2140, kerning parameters 2150, and leading parameters 2160. The font sizes parameters specifies the range of font sizes or list of absolute font sizes available to the fitting algorithm for adjusting headline font sizes. For example, font sizes parameters 2140 is shown with the list of absolute font size values of 8, 9, 10, 11, 12, . . . . Consequently, the fitting algorithm would not be permitted to set the font size to 7 points because it falls below the minimum font size. The list of font sizes corresponds with lists of other related parameters, such as the kerning parameters 2150. The kerning parameters 2150 specify the range or list of acceptable kerning (i.e., character spacing), between the characters, or letters, of the headlines on the index page. The list of kerning values correspond with the list of font sizes. For example, in the present embodiment, the first three listed font sizes 8, 9, and 10 correspond to the first three listed kerning values, namely −0.7, −0.7, and −0.7. This listing provides one example to show how a single kerning value may be appropriate for a range of font sizes. Similarly, the leading parameters 2160 specify the range or list of acceptable leading (i.e., line spacing) between the lines of a headline on the index page. In the present embodiment, the first three listed font sizes 8, 9, and 10 correspond to the first three listed minimum and maximum leading values, namely −2 to 5, −2 to 5, and −2 to 5.

The index page preview max width and height parameters 2070 specify the maximum dimensions (i.e., height and width) of an article preview. The treemapping algorithm may use these maximum values to constrain the size of any region generated for a single article preview.

Index page headline size float parameter 2180 specifies how the whitespace between the headline and the body content may be calculated, wherein the amount of whitespace may be proportional to the size of the headline according to the value of the headline size float parameter 2180.

Additional advanced parameters include a screen dots per centimeter (DPC) parameter 2190 and a column justify parameter 2195. The screen DPC parameter 2190 specifies the resolution or density of pixels on the screen. The column justify parameter 2095 specifies whether the article preview text should be left-justified or full justified within the column(s) of the text. In this embodiment, if the parameter 2095 equals “1,” the text is left-justified, and if the parameter equals “0,” it is full-justified. Index page “B 1st Snt” (i.e., “bold first sentence”) parameter specifies whether the first sentence in an article preview should be bold.

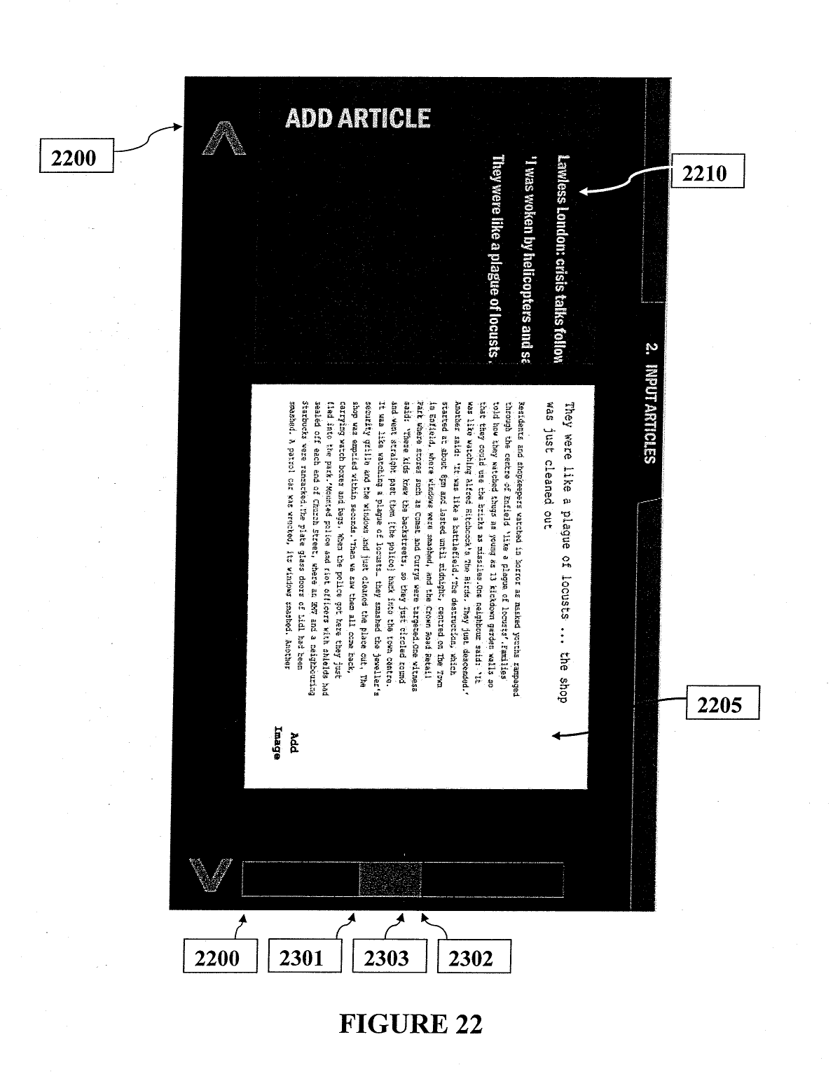

In some embodiments, a user of the ePagination system may input information about articles directly into the system, rather than receiving the information from one of the external sources 201-205. For instance, FIG. 22 shows an example of an interface 2200 that provides a text box 2205 for typing or pasting article text, adding images, adding additional articles, and switching among articles already added. An article list 2210 shows a list of headlines for articles that the user has already added. The user may also click on or otherwise select a headline to select the article. The selected article is displayed in the text box 2205 for viewing or further editing.

The ePagination system may compute the minimum and maximum height of the article based on preconfigured typographic parameters such as the parameters in FIGS. 18 and 19. In some embodiments, the ePagination system may display a sizing indicator such as sizing bar 2300. The sizing bar 2300 indicates whether the articles in the list 2210 may be laid out in a way that provides a snuggly fit for all articles. A minimum total height indicator 2301 indicates the total height or size of the articles if each article is laid out according to the minimum values for the typographic parameters. A maximum total height indicator 2302 indicates the total height or size of the articles if each article is laid out according to the maximum values for the typographic parameters. A snug fit is possible when the region between the minimum total height 2301 and the maximum total height 2302 overlaps with the optimal height indicator 2303. The region between heights 2301 and 2302 represent the range of possible total heights for the articles as entered and listed in article list 2210. The overlap of this region with optimal height indicator 2303 indicates that it is possible to lay out the articles according to values for the typographic values that produce a total height that is the same or nearly the same as the optimal total height.

If the region between the minimum and maximum total heights 2301 and 2302 do not overlap with the optimal height indicator 2303, the resulting layout may not provide a snug fit for all of the articles. In this situation, a user or content provider may edit existing articles or add additional articles until the sizing bar 2300 shows that an optimal layout is possible.

FIG. 23 shows an example of an interface that a content provider or other user may manipulate to adjust values of typographic parameters or other settings of an index page and observe how the adjusted values affect the look-and-feel of the index page in real time. This example is one embodiment of the real-time layout creator 340 (FIG. 3). As shown, the interface includes a preview pane 2300 and a weightings widget 2350.

The preview pane 2300 shows the relative sizes and positions of headlines for three article previews 2351, 2354, and 2355 on a preview index page. The relative visual weightings of the three article previews 2351, 2354, and 2355 are determined by the weightings widget 2350.

In the present example, the widget 2350 shows that the lead article preview 2351 has a relative visual weighting of 46% and that the other article previews 2354 and 2355 have weightings of 30% and 24%, respectively. The relative weightings of the article previews 2351, 2354, and 2355 are reflected in the preview pane 2300. In this example, the relative weightings of the previews 2341, 2354, and 2355 are shown only by the relative sizes of their headlines. If the user is satisfied with the relative weightings for the article previews 2341, 2354, and 2355 upon reviewing the preview pane 2300, he or she can press the widget button 2352. In response, the screen-based index page creator 310 finishes generating the rest of the article previews 2351, 2354, and 2355 according to the weightings shown in the widget 2350 and the layout shown in the preview pane 2300. After the index page is created, the page layout creator 320 may create the page layouts containing the articles corresponding to the article previews 2341, 2354, and 2355.

While the present embodiment previews the relative weightings by showing only the headlines of the previews 2351, 2354, and 2355, other embodiments may include additional or all of the elements of the article previews 2351, 2354, and 2355 in the preview pane to show the relative weightings. Furthermore, the page layout creator 320 may immediately begin creating the page layouts for the articles corresponding to the article previews 2351, 2354, and 2355 instead of waiting for the screen-based index page creator 310 to finish creating the index page.

If the user desires to change the relative weightings of the article previews 2351, 2354, and 2355, he or she can manipulate the weightings widget 2250 to adjust the weightings. In one embodiment, the weightings widget 2250 contains adjusters 2353 that the user can “click-and-drag” around the circular widget 2350.

For example, initially, as shown in FIG. 23, the weighting of the first article preview 2351 is 46%, the weighting of the second article preview 2354 is 30%, and the weighting of the third article 2355 preview is 24%. Subsequently, the user can select the adjuster 2353 between the first and third article previews 2351 and 2355 on the weightings widget 2251 and drag the adjuster 2353 around the widget 2350 to change the relative weightings between the article previews 2351 and 2355. For example, as shown in FIG. 24, the user can drag the adjuster 2353 (between the articles 2351 and 2355) until the weighting of the first article preview 2351 increases by 4% to 50% and the weighting of the third article preview 2355 simultaneously decreases by 4% to 20%. As the weightings are adjusted, the sizes of the headlines, in the preview panes 2300 and 2400 for all of the previews 2351, 2354, and 2355 change in real time to reflect the relative weightings on the widget 2350. Since the adjuster 2353 between the second and third article previews 2354 and 2355 is not moved in this example, the relative visual weighting of the second article 2354 remains unchanged at 30%. If the user would like to create an index page with these revised weightings, he or she can select the widget button 2352, as described above.

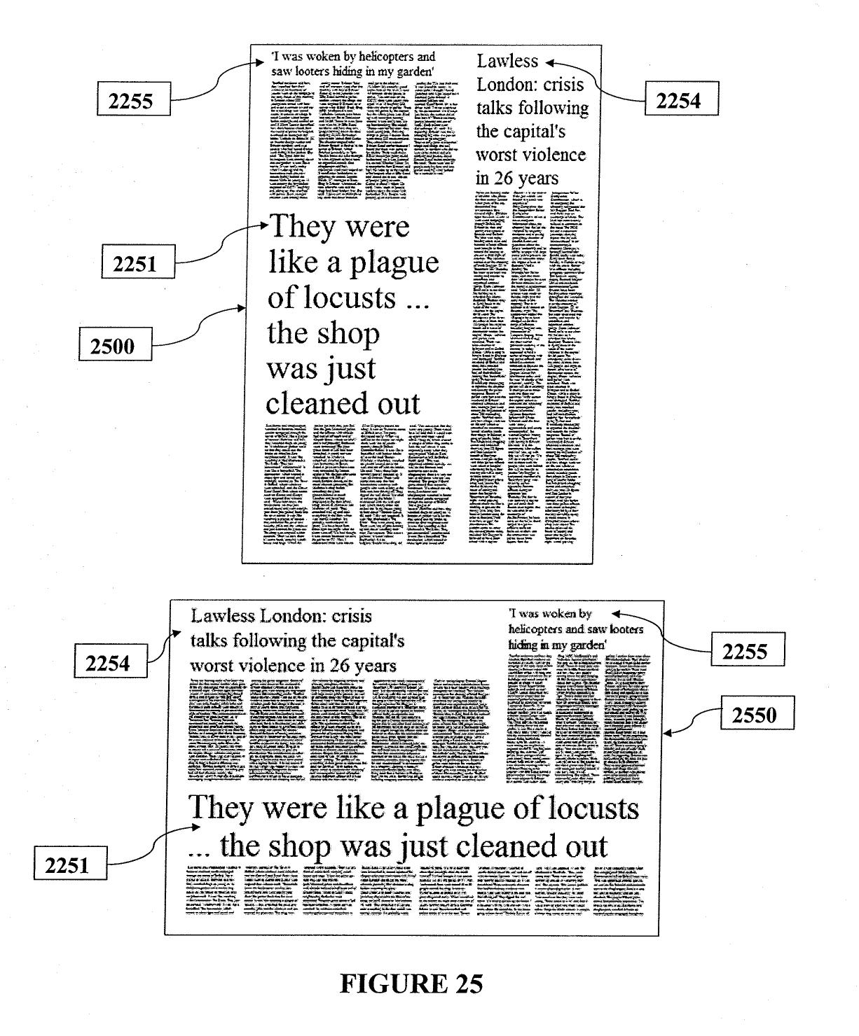

After selecting the button 2352, the screen-based index page creator 310 fits the article preview text around the headlines within the preview pane 2400. For example, as shown in FIG. 25, the review pane 2500 shows the index page after the creator 310 fills in the article preview text around the headlines shown in preview pane 2400 (FIG. 24).

The preview pane 2550 illustrated in FIG. 25 shows an example of a landscape orientation when the canvas (e.g., the screen of a tablet 212) is rotated by 90 degrees. The ePagination system makes an effort to maintain the relative sizes and positions of the headlines and articles previews 2251, 2254, and 2255 when in the rotated orientation.

FIG. 26 shows yet another embodiment in which a weightings widget 2650 is used to adjust the relative weightings of four article previews 2660, 2670, 2680, and 2690 instead of three. The preview pane 2500 shows a real time layout of the four article previews 2660, 2670, 2680, and 2690 according to the relative weightings shown in weightings widget 2550.

FIG. 27 illustrates an example in which the user does not change the weightings of the article previews 2660, 2670, 2680, and 2690 shown in FIG. 26 and instead just simply inputs a command to change the layout of the previews 2660, 2670, 2680, and 2690. In this case, a new preview pane 2700 is created in which the layout of the article previews 2660, 2670, 2680, and 2690 is different than the layout in preview pane 2600 of FIG. 26. The two preview panes 2600 and 2700 show two different layouts for the same headlines with the same visual weightings. This may be attributed to the quasi-random fitting algorithm and quasi-randomized reordered treemapping algorithm used to generate the regions in which the headlines are fit. Running the real time layout creator multiple times creates varying typographically correct layouts with adequate fitness. A content or other provider may store multiple layouts and later select a preferred layout for publication.

At this point it should be noted that typographic electronic pagination in accordance with the present disclosure as described above may involve the processing of input data and the generation of output data to some extent. This input data processing and output data generation may be implemented in hardware or software. For example, specific electronic components may be employed in a typographic electronic pagination module or similar or related circuitry for implementing the functions associated with typographic electronic pagination in accordance with the present disclosure as described above. Alternatively, one or more processors operating in accordance with instructions may implement the functions associated with typographic electronic pagination in accordance with the present disclosure as described above. If such is the case, it is within the scope of the present disclosure that such instructions may be stored on one or more non-transitory processor readable storage media (e.g., a magnetic disk, solid state memory, or other storage medium), or transmitted to one or more processors via one or more signals embodied in one or more carrier waves.

The present invention is not to be limited in scope by the specific embodiments described herein. Indeed, other various embodiments of and modifications to the present disclosure, in addition to those described herein, will be apparent to those of ordinary skill in the art from the foregoing description and accompanying drawings. Thus, such other embodiments and modifications are intended to fall within the scope of the present invention. Further, although the present disclosure has been described herein in the context of particular implementations in at least one particular environment for at least one particular purpose, those of ordinary skill in the art will recognize that its usefulness is not limited thereto and that the present invention may be beneficially implemented in any number of environments for any number of purposes.

1. An apparatus for typographic electronic pagination comprising:
at least one non-transitory processor readable storage medium; and
instructions stored on the at least one medium,
wherein the instructions are configured to be readable by at least one non-transitory processor and to cause the at least one processor to operate so as to:
(a) receive a plurality of articles; and
(b) generate an index page based on relative visual weightings of the plurality of articles and a size of a canvas adapted to contain the index page.

2. The apparatus of claim 1, wherein the instructions further cause the at least one processor to:
(c) assign the relative visual weightings to the plurality of articles, respectively.

3. The apparatus of claim 1, wherein the instructions further cause the at least one processor to:
(c) receive the size of the canvas from a client device containing the canvas.

4. The apparatus of claim 1, wherein operation (b) further comprises:
(b1) generate article previews corresponding to the plurality of articles,
wherein the plurality of articles comprises a lead article and a second article,
wherein the article previews include a lead article preview corresponding to the lead article and a second article preview corresponding to the second article, and
wherein the lead article preview has a lead preview size and the second article preview has a second preview size; and
(b2) determine whether the article previews together fit within the size of the canvas.

5. The apparatus of claim 4, wherein operation (b1) comprises:
(b1a) set the lead preview size of the lead article preview to a first preview size of the article previews; and
(b1b) set the second preview size of the second article preview to the second preview size relative to the lead preview size of the lead article preview,
wherein the second preview size is smaller than the lead preview size, and
wherein relative sizes of the lead preview size and the second preview size correspond to the relative visual weightings of the lead article preview and the second article preview.

6. The apparatus of claim 5, wherein the first preview size is a predetermined maximum potential size of the article previews.

7. The apparatus of claim 5, wherein the instructions further cause the at least one processor to:
(b3) if the article previews together do not fit within the size of the canvas,
(b3a) reduce the lead preview size of the lead article preview and second preview size of the second article preview according to the relative visual weightings; and
(b3b) repeat operation (b2).

8. The apparatus of claim 7, wherein operation (b3a) comprises:
(b3a1) reduce the lead preview size by reducing a size of at least one element of the lead article preview; and
(b3a2) reduce the second preview size by reducing a size of at least one element of the second article preview.

9. The apparatus of claim 8, wherein the at least one element of the lead article preview comprises at least one of font size of a headline of the lead article preview, a font size of the text of the lead article preview, and a size of an image of the lead article preview, and
wherein the at least one element of the second article preview comprises at least one of font size of a headline of the second article preview, a font size of the text of the second article preview, and a size of an image of the second article preview.

10. The apparatus of claim 8, wherein the size of the at least one element of the lead article preview is reduced by eliminating the at least one element of the lead article preview.

11. The apparatus of claim 8, wherein the size of the at least one element of the second article preview is reduced by eliminating the at least one element of the second article preview.

12. The apparatus of claim 4, wherein the instructions further cause the at least one processor to:
(b3) if the article previews together fit within the size of the canvas, arrange the article previews in the canvas according to a treemapping of the article previews.

13. The apparatus of claim 7, wherein the instructions further cause the at least one processor to:
(b4) if the article previews together fit within the size of the canvas, arrange the article previews in the canvas according to a treemapping of the article previews.

14. The apparatus of claim 1, wherein operation (b) comprises:
(b1) generate the index page based on the relative visual weightings of the plurality of articles, the size of the canvas, and the canvas oriented in a first orientation, and
wherein the instructions further cause the at least one processor to:
(c) generate a second index page based on the relative visual weightings of the plurality of articles, the size of the canvas, and the canvas oriented in a second orientation.

15. The apparatus of claim 14, wherein the first orientation is a first one of a portrait orientation and a landscape orientation, and
wherein the second orientation is a different second one of the portrait orientation and the landscape orientation.

16. The apparatus of claim 1, wherein the relative visual weighting of each article is based at least in part on a publication date of each article.

17. The apparatus of claim 16, wherein a first relative visual weighting of an earlier published article is less than a second relative visual weighting of a later published article.

18. The apparatus of claim 16, wherein the instructions further cause the at least one processor to select a most recently published article of the plurality of articles as a lead article.

19. The apparatus of claim 1, wherein operation (b) comprises:
(b1) generate an article preview corresponding to one of the plurality of articles; and
(b2) adjust columns of the article preview.

20. The apparatus of claim 19, wherein operation (b2) comprises:
(b2a) adjust a number of the columns.

21. The apparatus of claim 19, wherein operation (b2) comprises:
(b2a) adjust a size of the columns.

22. The apparatus of claim 21, wherein operation (b2a) comprises:
(b2a1) adjust a spacing between a column and at least one other element of the article preview.

23. The apparatus of claim 1, wherein the instructions further cause the at least one processor to:
(c) receive a first adjustment of at least one of the relative visual weightings.

24. The apparatus of claim 23, wherein the instructions further cause the at least one processor to:
(d) generate a second index page based on the first adjustment.

25. The apparatus of claim 1, wherein the instructions further cause the at least one processor to:
(d) receive successive adjustments of the relative visual weightings; and
(e) generate an indication of a layout of the index page in real time in response to receiving each of the successive adjustments.

26. An apparatus for typographic electronic pagination comprising:
at least one non-transitory processor readable storage medium; and
instructions stored on the at least one medium,
wherein the instructions are configured to be readable by at least one non-transitory processor to cause the at least one processor to operate so as to:
(a) receive a plurality of articles; and
(b) generate a page layout for the plurality of articles based on page layout weightings and a size of a canvas adapted to contain the page layout.

27. The apparatus of claim 26, wherein the instructions further cause the at least one processor to:
(c) assign page layout weightings to the plurality of articles, respectively.

28. The apparatus of claim 26, wherein the instructions further cause the at least one processor to:
(c) receive the size of the canvas from a client device containing the canvas.

29. The apparatus of claim 26, wherein operation (b) further comprises:
(b1) determine sizes for the plurality of articles corresponding to the page layout weightings.

30. The apparatus of claim 29, wherein the plurality of articles comprises a first article and a second article,
wherein the first article has a first page layout weighting of the page layout weightings and the second article has a second page layout weighting of the page layout weightings,
wherein operation (b1) comprises:
(b1a) determine a first range of sizes of the first article based on a first range of typographical parameters corresponding to the first page layout weighting;
(b1b) determine a second range of sizes of the second article based on a second range of typographical parameters corresponding to the second page layout weighting; and
(b1c) determine a first size, within the first range of sizes, of the first article and a second size, within the second range of sizes, of the second article such that the aggregated sizes of the plurality of articles correspond to the size of the page layout.

31. The apparatus of claim 30, wherein operation (b1c) comprises:
(b1c1) determine the sizes of the plurality of articles, including the first size of the first article and the second size of the second article, such that a sum of the sizes of the plurality of the articles corresponds to an integer multiple of the size of the canvas.

32. The apparatus of claim 31, wherein a page size of each page of the page layout corresponds to the size of the canvas,
wherein the first size of the first article is greater than the page size such that an initial portion of the first article equals the page size and such that a sum of the initial portion and an overflow portion of the first article is greater than the page size,
wherein the second size of the second article is less than the page size such that a sum of an initial portion of the second article and an underflow portion corresponding to the second article equals the page size, and
wherein operation (b1c1) further comprises:
(b1c1a) determine the size of the first article and the second article such that an overflow size of the overflow portion the first article corresponds to an underflow size of the underflow portion of the second article.

33. The apparatus of claim 32, wherein the overflow size equals the underflow size.

34. The apparatus of claim 32, wherein a size difference between the overflow size and the underflow size is less than a predetermined threshold.

35. The apparatus of claim 32, wherein operation (b) further comprises:
(b2) arrange the plurality of articles on the pages of the page layout according to the sizes of the plurality articles.

36. The apparatus of claim 35, wherein operation (b2) further comprises:
(b2a) arrange the plurality of articles such that:
(b2a1) the initial portion of the first article is contained on one page of the page layout;
(b2a2) the overflow portion of the first article is contained on a next page of the page layout; and
(b2a3) the second article is contained on the next page.

37. The apparatus of claim 36, wherein a difference between (1) cumulative sum of the sizes of the initial portion of the first article, the overflow portion of the first article, and the second article and (2) the cumulative sum of the sizes of the one page and the next page is less than a predetermined threshold.

38. The apparatus of claim 35, wherein operation (b) further comprises:
(b3) match the first article with the second article such that a first value of a typographical parameter of the first article corresponds to a second value of the typographical parameter of the second article.

39. The apparatus of claim 38, wherein the first article and second article are located on successive pages of the page layout, and
wherein the instructions further cause the at least one processor to match articles on successive pages of the page layout.

40. The apparatus of claim 38, wherein operation (b3) comprises:
(b3a) match the first article with the second article such that first value equals the second value.

41. The apparatus of claim 38, wherein operation (b3) comprises:
(b3a) match the first article with the second article such that a difference between the first value and the second value of the typographical parameter is less than a predetermined threshold difference.

42. The apparatus of claim 38, wherein the typographical parameter is a kerning of an article.

43. The apparatus of claim 38, wherein the typographical parameter is a number of columns of text in the article.

44. The apparatus of claim 26, wherein at least one article of the plurality of articles comprises an image.

45. The apparatus of claim 26, wherein operation (b) comprises:
(b1) generate the page layout for the plurality of articles based on the page layout weightings, the size of the canvas, and the canvas oriented in a first orientation, and
wherein the instructions further cause the at least one processor to:
(c) generate a second page layout for the plurality of articles based on the page layout, the size of the canvas, and the canvas oriented in a second orientation.

46. The apparatus of claim 45, wherein the first orientation is a first one of a portrait orientation and a landscape orientation, and
wherein the second orientation is a different second one of the portrait orientation and the landscape orientation.

47. The apparatus of claim 26, wherein the page layout weighting of each article is based at least in part on a publication date of each article.

48. The apparatus of claim 47, wherein a first page layout weighting of an earlier published article is lower than a second page layout weighting of a later published article.

49. The apparatus of claim 26, wherein operation (b) comprises:
(b1) generate the page layout for the plurality of articles; and
(b2) adjust columns of at least one article of the plurality of articles.

50. The apparatus of claim 49, wherein operation (b2) comprises:
(b2a) adjust a number of the columns.

51. The apparatus of claim 49, wherein operation (b2) comprises:
(b2a) adjust a size of the columns.

52. The apparatus of claim 51, wherein operation (b2a) comprises:
(b2a1) adjust a spacing between a column and at least one other element of the at least one article.

53. The apparatus of claim 30, wherein a size of at least one advertisement is fixed,
wherein operation (b) comprises:
(b2) arrange the at least one advertisement within at least one page of the page layout for the plurality of articles, and
wherein operation (b1a) comprises:
(b1a1) determining the first range of sizes of the first article by accounting for the fixed size of the at least one advertisement.

54. An apparatus for typographic electronic pagination comprising:
at least one non-transitory processor readable storage medium; and
instructions stored on the at least one medium,
wherein the instructions are configured to be readable by at least one non-transitory processor and to cause the at least one processor to operate so as to:
(a) receive a plurality of articles; and
(b) generate an index page based on relative visual weightings of the plurality of articles and a size of a canvas adapted to contain the index page; and
(c) generate a page layout for the plurality of articles based on page layout weightings and the size of canvas.

55. The apparatus of claim 54, wherein the index page comprises at least one hyperlink to one of the articles in the page layout.

56. The apparatus of claim 54, wherein the index page comprises at least one cross reference corresponding to at least one page number of at least one page in the page layout.

57. The apparatus of claim 54, wherein at least one page of the page layouts comprises an advertisement.
